(19) United States
(12) Patent Application Publication
(10) Pub. No.: US 2012/0259776 A1
(43) Pub. Date: Oct. 11, 2012

(54) DYNAMIC PRE-QUALIFICATION

(75) Inventors: Hitesh Bajaj, Charlotte, NC (US); Amlan Banerjee, Charlotte, NC (US); Ray R. Hernandez, Charlotte, NC (US); Charles F. Pigg, Plano, TX (US); Andrew L. Saar, Sandy Springs, GA (US)

(73) Assignee: BANK OF AMERICA CORPORATION, Charlotte, NC (US)

(21) Appl. No.: 13/083,325

(22) Filed: Apr. 8, 2011

(51) Int. Cl. G06Q 40/00

(52) U.S. Cl. 705/42; 705/35

(57) ABSTRACT

Embodiments of the invention are directed to systems, methods and computer program products for determining whether an account is eligible to participate in a banking service. In some embodiments, a method includes: (a) receiving information associated with an account; (b) determining, based at least partially on the information, that the account is eligible to participate in a banking service; and (c) presenting, in an electronic banking environment accessible to a holder of the account, an identifier associated with the banking service, where the presenting is based at least partially on the determining that the account is eligible. In some embodiments, the method further includes activating the banking service for the account. In some embodiments, the identifier is embodied as an input feature that enables the holder to enroll in the banking service. In other embodiments, the identifier is embodied as an input feature that enables the holder to use the banking service.

### BACKGROUND

In a business environment, risk is sometimes defined as an event, situation, or condition that may occur, and if it occurs, will impact the ability of a business to achieve its desired objectives. In some cases, risk management involves: (a) defining events, situations, or conditions and their potential impact to the business, clients, and/or the like; (b) detecting those defined events when they occur; (c) executing a pre-defined set of actions to minimize negative impacts based upon the level of threat and client impact of mitigation alternatives (e.g., risk mitigation, prevention and the like); and/or (d) when unable to prevent a risk event from negatively impacting, executing a set of actions to recover all or part of the loss. In some cases, recovery includes taking legal action against the entity causing the loss. Therefore, there is a need for financial institutions to monitor and mitigate risk. One way to mitigate risk is to prevent potential fraudsters from having access to one or more services associated with their banking accounts.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing apparatuses (e.g., a system, computer program product, and/or other device), methods, or a combination of the foregoing for determining that an account associated with a financial institution is eligible to participate in a banking service. For instance, a method is provided for determining that an account is eligible to participate in a banking service. In some embodiments, the method includes receiving information associated with an account. Additionally, the method includes determining, using a processor and based at least partially on the information, that the account is eligible to participate in a banking service. Additionally, the method includes presenting, in an electronic banking environment accessible to a holder of the account, an identifier associated with the banking service, where the presenting is based at least partially on the determining that the account is eligible. In some embodiments, the determining occurs dynamically and/or in real-time upon determining that the holder has accessed the electronic banking environment. In another embodiment, the determining occurs within a short period of time (e.g., thirty seconds, two or three minutes, etc.) after initiation of an electronic banking application.

In some embodiments, the identifier includes an input feature that enables an account holder to enroll in the banking service. In some embodiments, the method further includes, activating the banking service for the account based at least partially on a determination that the holder has enrolled in the banking service. In some embodiments, the method further includes presenting a second identifier in the electronic banking environment after the activating the banking service, where the second identifier enables the holder to use the banking service. In some embodiments, the method further includes an input feature that enables the holder to use the banking service. In some embodiments, the method further includes activating the banking service for the account based at least partially on the determining that the account is eligible.

In some embodiments, the method further includes receiving second information associated with the account, where the receiving the second information occurs after the presenting the identifier. Additionally, the method includes determining, based at least partially on the second information, that the account is ineligible to participate in the banking service. Additionally, the method includes deactivating the banking service for the account based at least partially on the determining that the account is ineligible.

In some embodiments, the method further includes receiving second information associated with the account, where the receiving the second information occurs after the presenting the identifier. The method additionally includes determining, based at least partially on the second information, that the account is ineligible to participate in the banking service. The method additionally includes removing the identifier from the electronic banking environment based at least partially on the determining that the account is ineligible.

In some embodiments, the method further includes receiving second information associated with the account, where the receiving the second information occurs after the presenting the identifier. The method additionally includes determining, based at least partially on the second information, that the account is ineligible to participate in the banking service. The method additionally includes presenting, in the electronic banking environment, a message that indicates that the banking service will be deactivated, where the presenting the message is based at least partially on the determining that the account is ineligible.

In some embodiments, the method includes a recommendation for preventing deactivation of the banking service. In some embodiments, the information associated with the account includes information associated with the holder. In some embodiments, the information associated with the account includes a risk rating associated with the account. In some embodiments, the method further includes determining that the holder has accessed the electronic banking environment, where the receiving the information is triggered by the determining that the holder has accessed the electronic banking environment. In some embodiments, the method further includes determining that the holder has accessed the electronic banking environment, where the receiving the information, the determining that the account is eligible, and the presenting the identifier all occur within approximately two minutes of the determining that the holder has accessed the electronic banking environment. In some embodiments, the method further includes determining that the holder has selected the identifier, where the receiving the information, the determining that the account is eligible, and activating the banking service for the account, based at least partially on the determining that the account is eligible, all occur within approximately two minutes of the determining that the holder has selected the identifier. In some embodiments, the identifier includes information indicating that the banking service has been activated for the account.

In some embodiments, the electronic banking environment includes a mobile banking environment accessible to the holder via a mobile phone, where the mobile banking environment is configured to output transaction information associated with the account to the holder, and where the mobile banking environment enables the holder to perform one or more transactions using the account. In some embodiments, the electronic banking environment includes a mobile banking environment accessible to the holder via a remote capture device, and where the banking service includes a mobile deposit service that enables the holder to perform a deposit transaction involving the account and using the remote capture device.

In some embodiments, another method is provided to determine whether an account is eligible to participate in a banking service. The method includes receiving a risk rating associated with an account. The method further includes determining, using a processor and based at least partially on the risk rating, that the account is eligible to participate in a mobile deposit service. The method further includes presenting, in a mobile banking environment accessible to a holder of the account, an identifier associated with the mobile deposit service, where the presenting is based at least partially on the determining that the account is eligible.

In some embodiments, the identifier includes an input feature that enables the holder to enroll in the mobile deposit service. In some embodiments, the identifier includes an input feature that enables the holder to use the mobile deposit service. In some embodiments, the method further includes activating the mobile deposit service for the account based at least partially on a determination that the holder has enrolled in the mobile deposit service. In some embodiments, the method further includes presenting a second identifier in the mobile banking environment after the activating the mobile deposit service, where the second identifier enables the holder to use the mobile deposit service.

In some embodiments, the method further includes activating the mobile deposit service for the account based at least partially on the determining that the account is eligible. In some embodiments, the method further includes receiving an updated risk rating associated with the account, where the receiving the updated risk rating occurs after the presenting the identifier. The method additionally includes determining, based at least partially on the updated risk rating, that the account is ineligible to participate in the mobile deposit service. The method additionally includes deactivating the banking service for the account based at least partially on the determining that the account is ineligible.

In some embodiments, the method further includes receiving an updated risk rating associated with the account, where the receiving the updated risk rating occurs after the presenting the identifier. The method additionally includes determining, based at least partially on the updated risk rating, that the account is ineligible to participate in the mobile deposit service. The method additionally includes removing the identifier from the electronic banking environment based at least partially on the determining that the account is ineligible. In some embodiments, the method further includes determining the risk rating associated with the account based at least partially on a transaction history associated with the account. In some embodiments, the determining that the account is eligible includes determining that the risk rating associated with the account is less than a predetermined risk threshold for participating in the mobile deposit service.

In some embodiments, the method further includes determining that the holder has accessed the mobile banking environment, where the receiving the risk rating is triggered by the determining that the holder has accessed the electronic banking environment. In some embodiments, the method further includes determining that the holder has accessed the electronic banking environment, and where the receiving the risk rating, the determining that the account is eligible, and the presenting the identifier all occur within approximately two minutes of the determining that the holder has accessed the mobile banking environment. In some embodiments, the method further includes determining that the holder has selected the identifier, where the receiving the risk rating, the determining that the account is eligible, and activating the mobile deposit service for the account based at least partially on the determining that the account is eligible all occur within approximately two minutes of the determining that the holder has selected the identifier.

In some embodiments, the mobile banking environment is accessible to the holder via a remote capture device, and the mobile deposit service enables the holder to perform a deposit transaction involving the account and using the remote capture device. One or more of the steps of the methods described herein may be executed via a processor such as a computing device processor.

In some embodiments, another method is provided for determining that an account is eligible to participate in a banking service. The method includes presenting, in an electronic banking environment accessible to a holder of an account, an identifier associated with a banking service. The method additionally includes determining that the holder has selected the identifier. The method additionally includes receiving, based at least partially on determining that the holder has selected the identifier, information associated with the account. The method additionally includes determining, using a processor and based at least partially on the information, that the account is eligible to participate in the banking service. In some embodiments, the method additionally includes activating the banking service for the account based at least partially on the determining that the account is eligible.

### BRIEF DESCRIPTION OF THE DRAWINGS

Having thus described embodiments of the invention in general terms, reference will now be made to the accompanying drawings, where:

FIG. 1 is a flowchart illustrating a general process flow for determining that an account is eligible to participate in a banking service, in accordance with an embodiment of the present invention;

FIG. 2 is a another flowchart illustrating a general process flow for determining that an account is eligible to participate in a banking service, in accordance with an embodiment of the present invention;

FIG. 3 is a flowchart that further explains FIG. 2, in accordance with an embodiment of the present invention;

FIG. 4 is a mixed block and flow diagram illustrating a system for processing a deposit transaction involving a mobile deposit service, in accordance with an embodiment of the present invention;

FIGS. 5-12 are illustrations of a graphical user interface used during the process of FIG. 2, in accordance with an embodiment of the present invention; and

FIG. 13 is a block diagram illustrating technical components of a system for determining whether an account is eligible to participate in a banking service, in accordance with an embodiment of the present invention.

### DETAILED DESCRIPTION OF EMBODIMENTS OF THE INVENTION

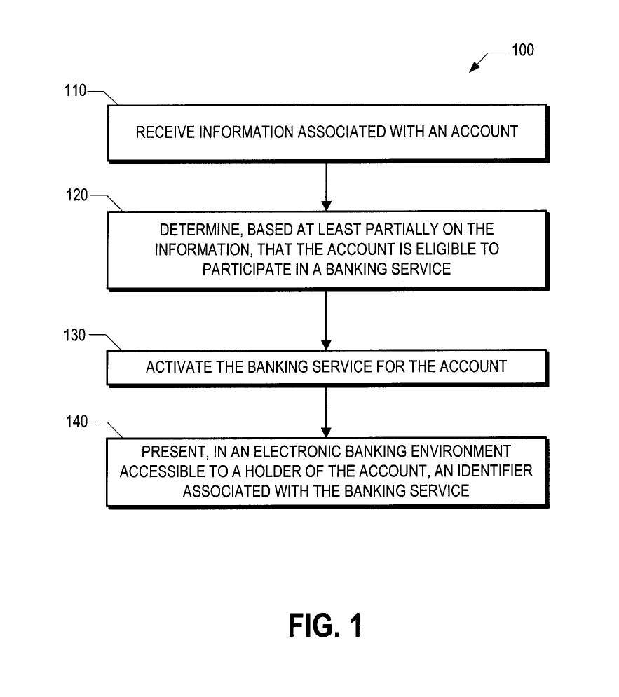

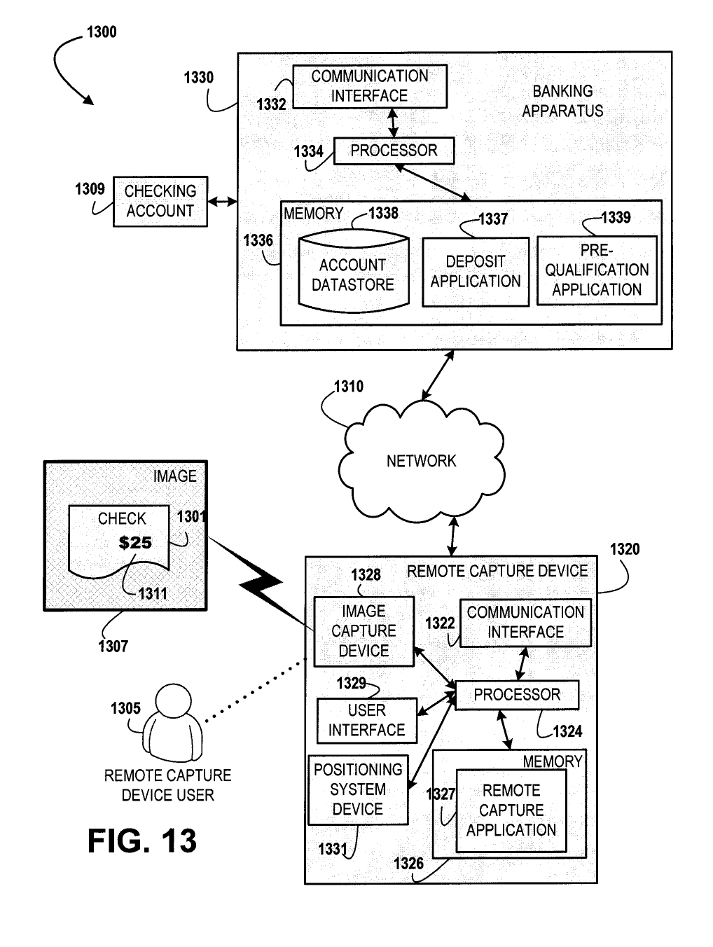

Referring now to FIG. 1, a general process flow 100 is provided for determining that an account is eligible to participate in a banking service, in accordance with embodiments of the present invention. In some embodiments, the process flow 100 is performed by an apparatus (e.g., banking apparatus 1330 illustrated in FIG. 13, remote capture device 1320, etc.) having hardware and/or software configured to perform one or more portions of the process flow 100. In such embodiments, as represented at block 110, the apparatus is configured to receive information associated with the account. As represented at block 120, the apparatus is configured to determine, based at least partially on the received information, that the account is eligible to participate in a banking service. As represented at block 130, the apparatus is configured to activate the banking service for the account. In some embodiments, the apparatus is configured to activate the banking service for the account based at least partially a determination that the account is eligible to participate in the banking service. Additionally or alternatively, in some embodiments, the apparatus is configured to activate the banking service for the account based at least partially on a determination that the account or account holder has enrolled in the banking service. As represented at block 140, the apparatus is configured to present, in an electronic banking environment accessible to a holder of the account, an identifier associated with the banking service. In some embodiments, the presenting is based at least partially on determining that the account is eligible to participate in the banking service.

In some embodiments, the account is associated with and/or maintained by a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. An “account” may be the relationship that an individual or a first entity such as a business organization, hereinafter referred to as the “user” or “client” or “account holder,” has with a second entity, which may be a financial institution. As used herein, a “user” may be someone other than an “account holder” who operates the account's holder's account. For instance, this account may be a deposit account, such as a transactional account (e.g., a checking account), a savings account, a money market account, a time deposit, a demand deposit, or a pre-paid account. This account could also be a credit account such that the account holder has a repayment or delivery obligation towards a second entity under previously agreed upon terms and conditions.

Regarding block 110, the received information may include both financial institution data and non-financial institution data associated with the account or the account holder. The financial institution data may include transactional level data (e.g., the transaction history associated with an account), such as checking transactions, ATM transactions, and credit/debit card transactions that allow for determination of an account holder's transactional behaviors. As used herein, a “transaction” may be monetary in nature (e.g., a purchase via a credit card; depositing a deposit item, e.g., a check, in an account; requesting a credit or cash advance; a stock trade or the like) or non-monetary in nature (e.g., a telephone call; an encounter with a financial institution or non-financial institution associate/representative; an identity authentication process, such as a biometric identity authentication process; recorded use of a utility, such as electricity and the like).

Additionally, the financial institution data may include account data, such as account balances and the like of the account, account balances and the like of other accounts held by account holder at the financial institution, ages of account holder's accounts, whether any of account holder's accounts were previously determined to be risky, any remarks associated with account holder's accounts, fees or fines incurred by the account under consideration on any of account holder's accounts, interest accrued by account, and account holder data, such as personal data, profile data, demographics data, contact information, and the like. In addition, data may be collected from non-financial institutions, such as consumer bureaus, business bureaus, retailers (online and brick & mortar) government agencies, Internet Service Providers (ISPs), telephone companies (Telcos), health care industry entities, and the like. The information obtained from consumer bureaus may include payment status on bills, payment status on accounts at other financial institutions, credit utilization ratios, length and variety of credit history, instances of credit inquiries, instances of charge-offs, instances of bankruptcy filings, instances of other delinquencies, or the like. The information from business bureaus may include bankruptcy filings, payment disputes with customers, payment of dues to business bureaus, information provided to business bureaus or the like. If the account holder is a business organization, the non-financial information may provide additional transactional information regarding the account holder, such as the type of business or operation that the account holder is engaged in, the reputation of the account holder, etc. If the account holder is an individual, the non-financial information may include the type of items purchased by the account holder and the like, behavioral data, such as purchasing or browsing behaviors, etc. The financial institution data and non-financial institution data may be captured in one or more risk databases that allow for analytics and/or logic to be performed on the data for the purpose of leveraging the collected data to define and identify various risk patterns and execute various routines/logic based on the identified risk patterns.

Regarding block 110, in some embodiments, the apparatus is triggered to receive information associated with an account when the account accesses an electronic banking environment (e.g., an account holder initiates or executes a banking application and authenticates himself/herself into an account). In other embodiments, an apparatus is configured to present a service identifier (e.g., a static service identifier such as static digital button) associated with a banking service in an electronic banking environment (e.g., on a mobile application interface). In some embodiments, this static identifier may always be presented in the electronic banking environment. In other embodiments, the static identifier may be presented in the electronic banking environment because an apparatus had previously determined that the account was eligible to participate in the service. In such embodiments, the apparatus is triggered to receive information associated with an account when an account holder selects the static identifier using any acceptable form of input (e.g., mouse, touch, voice, etc.). Thus, in such embodiments, even though an identifier associated with a service is present in the electronic banking environment, the apparatus dynamically activates the service for the account based at least partially on the information received at block 110. As explained later, the apparatus dynamically activates the service in real-time, or in substantially real-time, e.g., a short delay of few seconds (e.g., thirty seconds) or few minutes (e.g., two or three minutes).

Regarding block 120, as used herein, the term “eligible” means that the account and/or the account holder is qualified to use the banking service, as determined by the apparatus having the process flow 100. Exemplary banking services include, but are not limited to, funds transfers, mobile deposits (e.g., capturing an image of a check using a remote capture device and then using the image to perform a deposit transaction), bill payments, modifications to account profiles (e.g., changing the account holder's password, address, etc.), and/or the like.

In some embodiments, the apparatus having the process flow 100 may determine whether an account is eligible to participate in a banking service by executing one or more risk identification algorithms using the above-described financial institution data and/or non-financial institution data associated with the account under consideration or with the holder of the account under consideration. The apparatus' execution of the risk identification algorithms may produce a risk rating. A risk rating may be a metric to measure risk or an indicator of the amount of risk associated with an account or a holder of the account. In some embodiments, the risk rating is embodied as a risk score, such as, for example, a credit score provided by a third party credit bureau and/or an internal credit score calculated by the financial institution that maintains the account. In some embodiments, the risk rating may be standardized on a fixed scale, such as a scale from 1 to 100. Therefore, for example, a risk rating of ‘1’ or ‘A’ may correspond with risk scores from 70 to 100, a risk rating of ‘2’ or ‘B’ may correspond with risk scores from 30 to 70, and a risk rating of ‘3’ or ‘C’ may correspond with risk scores from 0 to 30. The logic/routine/formula used to compute a risk rating may vary from one account to another account, from one account holder to another account holder, from one service to another service, from one transaction to another transaction, etc.

Further regarding block 120, it will be understood that, in some embodiments, the term “determine” is meant to have its one or more ordinary meanings (i.e., its ordinary dictionary definition(s)), but in other embodiments, that term is additionally or alternatively meant to include the one or more ordinary meanings of one or more of the following terms: conclude, decide, identify, ascertain, find, discover, learn, verify, calculate, observe, read, and/or the like. Further, it will be understood that, in some embodiments, the phrase “based at least partially on” is meant to have its one or more ordinary meanings, but in other embodiments, that phrase is additionally or alternatively meant to include the one or more ordinary meanings of one or more of the following phrases: “in response to,” “upon or after,” “because of,” “as a result of,” “if,” “when,” and/or the like.

Regarding block 130, in some embodiments, the term “activate” refers to the act of the apparatus enrolling the holder and/or the account in the banking service. Additionally or alternatively, in some embodiments, the term “activate” refers to the act of the apparatus “turning on” the banking service for the account and/or the holder. Still further, in some embodiments, the term “activate” refers to the apparatus allowing and/or enabling the holder to use the banking service.

Regarding block 140, in some embodiments, the electronic banking environment refers to a graphical user interface (GUI) associated with the account. The electronic banking environment may permit online banking, mobile banking, text banking, or any other type of banking associated with the account. In some embodiments, the GUI enables an account holder to access information associated with the account. Additionally or alternatively, in some embodiments, the GUI enables the account holder to perform one or more transactions associated with the account (e.g., funds transfer, mobile deposit, bill payment, change mailing address, etc.). In some embodiments, the account is associated with an electronic banking account (e.g., online banking account, mobile banking account, etc.), and the electronic banking account may be embodied as and/or accessible via the electronic banking environment.

Further regarding block 140, as used herein, the term “identifier” may refer to one or more icons, buttons, links, images, characters, text, and/or the like. In some embodiments, the holder can select the identifier using any acceptable form of input (mouse-over input, touch screen input, a button input, a mouse click input, a keyboard input, a voice command input, or the like). In some embodiments, the identifier is embodied as, or includes, an input feature that enables the holder to enroll in the banking service. Additionally or alternatively, in some embodiments, the identifier is embodied as, or includes, an input feature that enables the holder to use the banking service. In other embodiments, the identifier includes information indicating that the banking service has been activated for the account.

It will be understood that the apparatus having the process flow 100 (and/or any of the apparatuses described and/or contemplated herein) can include one or more separate and/or different apparatuses. For example, in some embodiments, a combination of apparatuses (e.g., the banking apparatus 1330, the remote capture device 1320, etc.) is configured to perform the portions of the process flow 100 represented by blocks 110-140. However, in other embodiments, a single apparatus is configured to perform each and every portion of the process flow 100. In addition, in some embodiments, a first portion of an apparatus is configured to perform one or more portions of the process flow 100, and one or more other portions of the same apparatus are configured to perform the one or more other portions of the process flow 100.

In some embodiments, the apparatus having the process flow 100 is a remote capture device. The phrase “remote capture device,” as used herein, refers to an apparatus that is configured to generate, create, acquire, receive, view, and/or capture one or more still images and/or videos (collectively referred to herein as “images” for simplicity). In some embodiments, the remote capture device refers to an apparatus that houses one or more digital cameras, image sensors, lens, and/or other image capture devices. For example, in some embodiments, the remote capture device refers to a mobile phone having a digital camera housed therein. However, in other embodiments, the remote capture device refers to the image capture device itself. Referring to the example above, in accordance with some embodiments, the remote capture device refers to the digital camera that is housed in the mobile phone. As a variation of this example, in still other embodiments, the remote capture device refers to a digital camera that is not housed in the mobile phone, but is instead located adjacent, near, and/or otherwise proximate to the mobile phone (e.g., located within arm's reach of the mobile phone, etc.) and is operatively connected to (e.g., via wireline and/or wireless connection) the mobile phone. Thus, it will be understood that the remote capture device can be embodied as an apparatus (e.g., a mobile phone that houses a digital camera, etc.), as a component of the apparatus (e.g., a digital camera housed in a mobile phone, etc.), or as a peripheral device associated with the apparatus (e.g., a digital camera operatively connected to and located proximately to a mobile phone, etc.). Additionally, in some embodiments, the phrase “remote capture device” refers to a system having a remote capture device and a peripheral image capture device operatively connected to the remote capture device.

In addition, it will also be understood that the remote capture device is so named because it is typically located remotely from a traditional deposit location, such as, for example, a financial institution, a banking center, teller terminal, an ATM, and/or the like. Instead, the remote capture device is typically located in a home, an office, on a person, and/or remotely from a traditional deposit location. In addition, because a remote capture device is configured to perform portions of the process flows 100, 200, and/or 400, the remote capture device enables its user(s) to transform any location where the remote capture device is located into a deposit location. It will also be understood that the remote capture device is typically owned, operated, serviced, held, carried, possessed, controlled, and/or maintained (collectively referred to herein as “maintained” for simplicity) by a customer of a financial institution, i.e., an account holder who holds an account that is maintained by the financial institution.

Examples of remote capture devices include, but are not limited to, mobile phones (e.g., feature phones, smart phones, camera phones, etc.), cameras (e.g., digital cameras, video cameras, webcams, etc.), scanners (e.g., flatbed scanners, handheld scanners, etc.), personal digital assistants (PDAs), tablet computers (e.g., iPads®, etc.), gaming devices (e.g., Nintendo® DSi, Xbox 360® with Kinect sensor device, etc.), portable media players (e.g., iPods®, etc.), image capture devices (e.g., cameras, charge coupled devices (CCD), complementary metal-oxide-semiconductor (CMOS) sensors, other image sensors, etc.), as well as, in some embodiments, one or more components thereof and/or one or more peripheral devices associated therewith. Of course, it will be understood that, in some embodiments, the remote capture device is configured to perform one or more other functions (e.g., sending and/or receiving one or more phone calls, text messages, and/or other communications, etc.) in addition to generating and/or capturing one or more images. It will be further understood that, in some embodiments, the remote capture device refers to a wireline, non-portable, non-mobile, and/or non-handheld device, such as, for example, a flatbed scanner and/or a webcam. However, in other embodiments, the remote capture device refers to a wireless, portable, mobile, and/or handheld device, such as, for example, a handheld scanner and/or mobile phone. In some embodiments, the remote capture device could also represent any remote computing device or electronic kiosk associated with an account holder.

In some embodiments, the apparatus having the process flow 100 can be configured to perform any one or more portions of the process flow 100 represented by blocks 110-140 upon or after one or more triggering events, which, in some embodiments, is one or more of the other portions of the process flow 100. As used herein, it will be understood that a “triggering event” refers to an event that automatically triggers the execution, performance, and/or implementation of a triggered action, either immediately, nearly immediately (i.e., within minutes), or sometime after the occurrence of the triggering event. For example, in some embodiments, the apparatus is configured such that the apparatus receiving the transaction information (the triggering event) automatically and immediately triggers the apparatus to determine, based at least partially on the transaction information, that the account is eligible to participate in a banking service (the triggered action). In some embodiments, the apparatus is additionally or alternatively configured to activate the banking service for the account (triggered action) simultaneous with or sometime after (e.g., minutes after, hours after, etc.) determining, that the account is eligible to participate in a banking service (triggering event).

In some embodiments, a predetermined time and/or the passage of a predetermined period of time may serve to trigger one or more of the portions represented by blocks 110-140. Also, in some embodiments, the apparatus is configured to automatically perform one or more (or all) of the portions of the process flow 100 represented by blocks 110-140. In other embodiments, one or more (or all) of the portions of the process flow 100 represented by blocks 110-140 require and/or involve at least some human intervention. In addition to the process flow 100, any of the embodiments described and/or contemplated herein can involve one or more triggering events, triggered actions, automatic actions, apparatus actions, and/or human actions. Further, it will be understood that one or more portions of the process flow 100 can occur at any time with respect to the status of the transaction referred to in block 110. For example, in some embodiments, the apparatus is configured to perform one or more portions of the process flow 100 after the transaction is initiated and/or after the transaction is authorized but before the transaction is finalized.

It will also be understood that the apparatus having the process flow 100 can be configured to perform any one or more portions of any embodiment described and/or contemplated herein, including, for example, any one or more portions of the process flow 200 described later herein. In addition, the number, order, and/or content of the portions of the process flow 100 are exemplary and may vary. Indeed, the process flow 100, like all of the other process flows described herein, can include one or more additional and/or alternative process flow portions, and the apparatus configured to perform the process flow 100 can be configured to perform one or more additional and/or alternative functions.

In alternative embodiments, an apparatus that performs blocks 110 to 140 of FIG. 1 may be configured to perform another method for determining that an account is eligible to participate in a banking service. In such embodiments, the apparatus is configured to present, in an electronic banking environment accessible to a holder of an account, an identifier associated with a banking service. The apparatus is further configured to determine that the holder has selected the identifier. The apparatus is further configured to receive, based at least partially on determining that the holder has selected the identifier, information associated with the account. The apparatus is further configured to determine, using a processor and based at least partially on the information, that the account is eligible to participate in the banking service. In some embodiments, the apparatus is further configured to activate the banking service for the account based at least partially on the determining that the account is eligible to participate in the banking service.

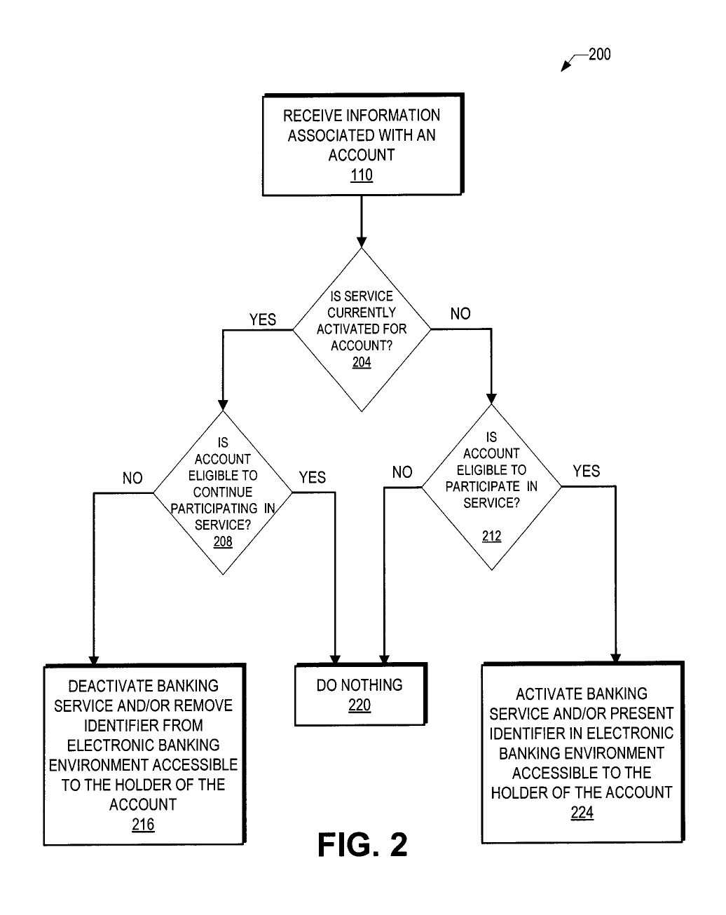

Referring now to FIG. 2, a process flow 200 is provided for determining that an account is eligible to participate in a banking service. In some embodiments, the process flow 200 in FIG. 2 is performed by an apparatus having hardware and/or software configured to perform one or more portions of the process flow 100 and/or 400. In some of these embodiments, the apparatus having the process flow 100 and/or 400 includes a banking apparatus 1330 and a remote capture device 1320. In some embodiments, the process flow 200 is provided for determining that an account is eligible to participate in a banking service at a point in time after an account was previously deemed to have been eligible to participate in the banking service and the identifier associated with the banking service was previously presented in an electronic banking environment associated with the account. Alternatively, in some embodiments, the process flow 200 is provided for determining that an account is eligible to participate in a banking service at a point in time after an account was previously deemed to have been ineligible to participate in a banking service and the identifier associated with the banking service was not previously presented in an electronic banking environment associated with the account.

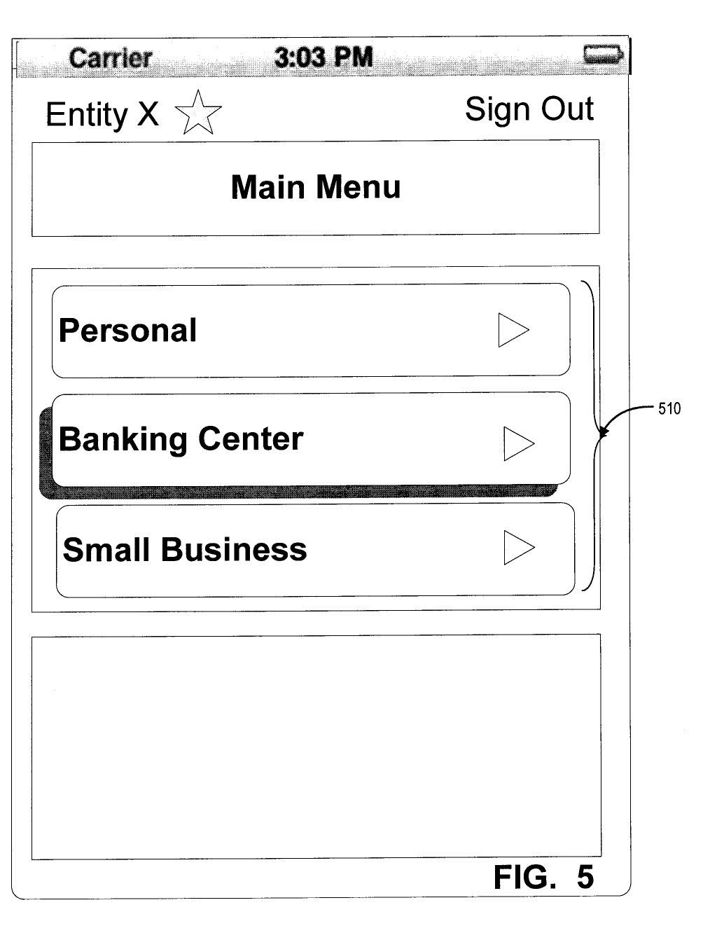

Referring now to block 110 of the process flow 200, an apparatus is configured to receive information associated with the account, e.g., the apparatus is configured to either receive account data or, in some embodiments, pull account data. This block is similar to block 110 discussed with respect to FIG. 1. In some embodiments, the account data may be received from various databases that are comprised of the below-described financial institution data and non-financial institution data. In some embodiments, the apparatus receiving the account data is triggered by the apparatus determining that the account or account holder has accessed an electronic banking environment (e.g., an account holder has initiated a mobile banking application on a mobile device). In other embodiments, the apparatus receives data for an account upon an account holder's selection of a particular channel in an electronic banking environment, e.g., a ‘Banking Center’ channel as displayed in FIG. 5. In some embodiments, the received data associated with an account includes data associated with one or more account-related transactions, data associated with the account, data associated with the account holder, etc. The received financial institution data may include transaction level data, such as checking transactions, ATM transactions, and credit/debit card transactions that allow for determination of an account's transactional behaviors. Checking transactions may include instances of deposit of deposit items, including whether there were any irregularities or problems with the deposit of deposit items. Transaction level data may also include frequency of different types of transactions, duration of time since the last transaction, amount of funds associated with the last transaction or with a set of transactions. Transaction level data may not only include transactions initiated by the account (e.g., funds transfers), but also transactions initiated by one or more systems with respect to the account (e.g., automatically changing a credit limit associated with an account). Additionally, the financial institution data may include account data, such as account balances and the like of the account, account balances and the like of other accounts held by the account holder at the financial institution, ages of account holder's accounts, whether any of account holder's accounts were previously determined to be risky (e.g., greater than a predetermined risk rating threshold), any remarks associated with account holder's accounts, fees or fines incurred by account holder on any of account holder's accounts, interest accrued by the account, and account holder data, such as personal data, profile data, demographics data, contact information, and the like.

In some embodiments, the received data includes non-account related data associated with the account holder. For instance, where the account holder is an individual, the data may include data associated with the account holder's credit report (or consumer bureau report). Where the account holder is a business organization, the data may additionally include data associated with the account holder's business bureau report. For instance, with respect to the account holder's credit report, the apparatus may identify any negative events that are pre-classified to be negative events. For instance, a late payment on a credit account at another financial institution or other entity that is reported on a consumer bureau report may be classified as a negative event. As a further instance, a late payment on a bill that is reported on a consumer bureau report may also be classified as a negative event. As a further instance, a high credit utilization ratio reported on a consumer bureau report may also be classified as a negative event, where the credit utilization ratio is the ratio of current credit balance to the total available credit limit. In some instances, a credit history shorter than a predetermined threshold period of time reported on a consumer bureau report may also be classified as a negative event. In some instances, if the account holder has not managed several different types of credit, that factor may also be classified as a negative event. In some instances, a credit inquiry made by certain types of entities as reported on a consumer bureau report may also be classified as a negative event. In some instances, a charge-off, a bankruptcy filing, or other delinquencies that are reported on a consumer bureau report may also be classified as negative events. In the event that consumer bureau information or business bureau information is included in the received data, the usage of the consumer bureau information and/or the business bureau information may be in compliance with one or more regulations, statues, laws, etc.

In some embodiments, there may be one or more local intermediary systems, each of which periodically, e.g., once per hour, receives data from the remote databases that include the above-described financial institution data and non-financial institution data. This intermediary system may further process the received data by highlighting accounts that have updated data. In another embodiment, the remote databases are designed to push updated data to the intermediary system, either periodically, or dynamically when the remote database receives an update associated with an account. Account updates may include various actions executed by an account holder, an agent, or a system with respect to an account. For instance, an account update may include an account holder updating a mailing address associated with an account. An account update may also include a funds transaction associated with an account. For the accounts with updated data, the intermediary system identifies risk patterns associated with the updated data by executing risk identification logic/routine for those accounts and calculating risk ratings associated with various services that are accessible by those accounts. For each account, the intermediary system may store in a local database the risk ratings associated with the various services that are accessible by those accounts, and decisions on whether an account is eligible to participate in those services. In such an embodiment, the apparatus receives these decisions from the intermediary system upon initiation of an electronic banking application. Alternatively or additionally, in some embodiments, the apparatus receives a risk rating associated with the account upon initiation of an electronic banking application. This embodiment may provide a faster method of rendering a decision of whether an account is eligible to participate in a service. In some embodiments, the apparatus receives this decision upon an account holder's selection of a particular channel of an electronic banking account, e.g., a ‘Banking Center’ channel as displayed in FIG. 5. In some embodiments, the intermediary system is part of the apparatus that performs various blocks of process flow 200, i.e., the apparatus performs the various functions performed by the intermediary system. In embodiments whether the intermediary system is separate from the apparatus, the intermediary system is similar to the apparatus and includes a memory, which stores various logic/routines, and a processor that executes the logic/routines.

Referring now to block 204, the apparatus having the process flow 200 determines whether a banking service is currently activated for the account. For instance, the service may be a mobile deposit service that allows the holder to make a deposit of a deposit item via a mobile device. As a further instance, another service may be a funds transfer service or a bill payment service. In some instances, the apparatus determines whether the account has previously used the service within a predetermined period of time in the past. The predetermined period of time in the past may vary from one account to another account. For instance, accounts with lower risk ratings may correspond with longer predetermined periods of time in the past, while accounts with high risk ratings may correspond with shorter predetermined periods of time in the past. The predetermined period of time may also depend on the type of service that is under consideration by the apparatus.

If the service is currently activated for the account, as represented by block 208, the apparatus determines whether the account is eligible (i.e., still eligible) to continue participating in the service. In some embodiments, this determination of eligibility is made dynamically in real-time, or in substantially real-time, e.g., a short delay of few seconds (e.g., thirty seconds) or few minutes (e.g., two or three minutes). In some embodiments, the apparatus having the process flow 200 is configured to make the eligibility determination based at least partially on a risk rating (and/or an updated risk rating (i.e., a risk rating determined after an earlier risk rating)) associated with the account.

If the apparatus determines at block 208 that the account is not eligible to continue participating in the service, then the apparatus removes the service identifier from the electronic banking environment, as represented by block 216. In some alternative embodiments, the service identifier is still presented in the electronic banking environment, but the identifier cannot be selected by the account holder, e.g., the account holder cannot select the service by clicking the identifier, touching the identifier, and/or otherwise selecting the service identifier using any acceptable form of input. In some embodiments, an error message may be displayed in a pop-window when an account holder attempts to select the identifier. In some embodiments, the electronic banking environment includes a link that allows the account holder to visit a page where the account holder can learn the reasons for the removal (or impending removal) of the service identifier. For instance, a reason may be that an account's risk rating has risen above a predetermined risk threshold for allowing the account to participate in the service. In some embodiments, the reason that contributed to the increased risk rating may be the number of overdrafts associated with the account during a predetermined period of time, e.g., the previous six months. In such embodiments, this reason may be communicated to the account holder as the reason for removing the service identifier.

In some embodiments, as represented by block 216, a message may be presented in the electronic banking environment recommending the account holder to call or otherwise contact (e.g., via email, chat, short messaging service (SMS), etc.) the financial institution. When the account holder contacts the financial institution, an agent associated with the financial institution may inform the account holder of the reason(s) why the service identifier was removed from the account's electronic banking environment and may recommend steps that can be taken by the account holder in order for the electronic banking environment to re-display the service identifier. The agent may also be able to review the account on a workstation interface associated with the agent. In some embodiments, the account holder may be allowed to appeal against the removal of the service identifier to the agent. If the agent is satisfied with the account holder's appeal, the agent may enter input into the agent's workstation (that is in network connection with the apparatus) that allows the service identifier to be re-displayed in an electronic banking environment associated with the account. In alternative embodiments, the electronic banking environment also presents a link that leads an account holder to a page that recommends one or more remedial or suggested actions that can be taken by the account holder. In some embodiments, when the account holder executes the one or more recommended remedial actions, the service identifier is re-displayed in the electronic banking environment. For instance, a remedial action may be a payment posted to the account. In other embodiments, when the account holder takes the one or more remedial actions, the service identifier is re-displayed in the electronic banking environment after further review by an agent at the financial institution. As used herein, an “agent” may be an analyst at a financial institution that reviews accounts. In some embodiments, the agent is a human, while in other embodiments, the agent may be a computer, e.g., a robot that is programmed to interact with the account holder.

In some alternative embodiments, as represented by block 216, if the apparatus determines that the account is not eligible for participating in the service, then the apparatus presents a warning message to the holder that indicates that the service will be deactivated (and/or the identifier will be removed) on a certain terminating date and/or time in the future. In some of these embodiments, the service identifier is still presented in the electronic banking environment, but the service identifier will be removed on a terminating date. In some embodiments, the electronic banking environment includes a link that allows the account holder to visit a page where the account holder can learn the reasons why the service identifier will be removed on the terminating date. For instance, a reason may be that an account's risk rating has risen above the maximum risk threshold for allowing the account to participate in the service. In one instance, the reason that contributed most heavily to the increased risk rating may be the number of overdrafts associated with the account during a predetermined period of time, e.g., the previous six months. Therefore, this reason may be communicated to the account holder as the reason why the service identifier will be removed on a terminating date in the future.

In some embodiments, as represented by block 216, a message may be presented in the electronic banking environment recommending the account holder to call or otherwise contact (e.g., via email, chat, short messaging service (SMS), etc.) the financial institution. When the account holder contacts the financial institution, an agent may inform the account holder of the reasons why the service identifier will be removed on the terminating date and may recommend steps that can be taken by the account holder in order for the electronic banking environment to prevent the removal the service identifier. The agent may also be able to review the account holder's account on a workstation interface associated with the agent. In some embodiments, the account holder may be allowed to appeal against the future removal of the service identifier to the agent. If the agent is satisfied with the account holder's appeal, the agent may enter input into the agent's workstation that allows the service identifier to continue to be displayed past the terminating date in an electronic banking environment associated with the account. In alternative embodiments, the electronic banking environment also presents a link that leads an account holder to a page that recommends one or more remedial or suggested actions that can be taken by the account holder. In some embodiments, when the account holder executes the one or more recommended remedial actions, the removal of the service identifier from the electronic banking environment is prevented. For instance, a remedial action may be a payment posted to the account. In other embodiments, when the account holder takes the one or more remedial actions, the service identifier's future removal from the electronic banking environment is prevented after further review by an agent at the financial institution.

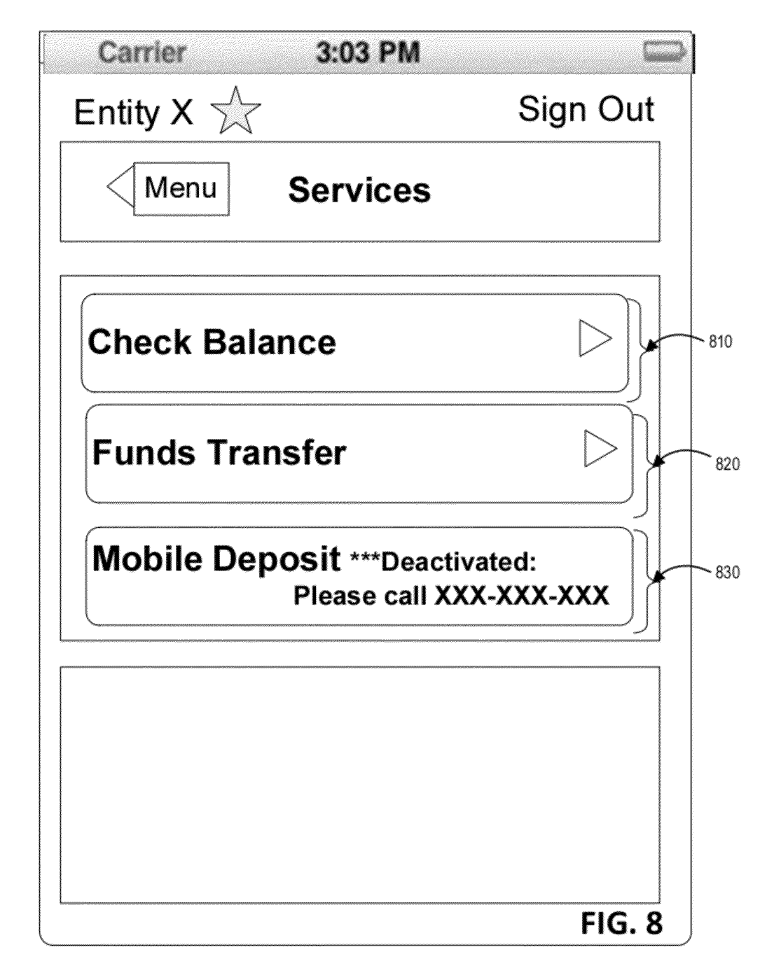

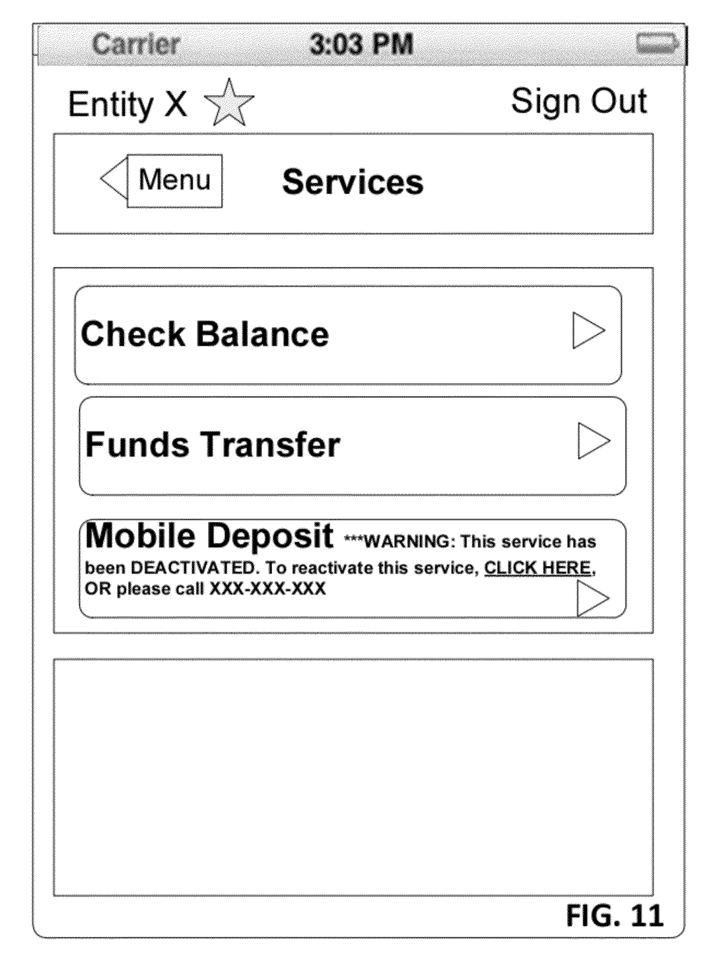

Additionally or alternatively, in some embodiments, as represented by block 216, the apparatus does not remove the service identifier from the electronic banking environment. Instead, the service identifier is displayed in the electronic banking environment, but the service identifier cannot be selected or activated by the account holder, i.e., the account holder cannot select the service by clicking the identifier, touching the identifier, or otherwise selecting the service identifier by any acceptable form of input. Therefore, in such embodiments, the identifier is deactivated. In some embodiments, an error message may be displayed in a pop-window when an account holder attempts to select the identifier. An example screenshot of this embodiment is presented in FIGS. 8 and 11.

If the apparatus determines that the account qualifies for the service as represented by block 208, then the apparatus does nothing (block 220). This means that the apparatus retains the status quo in the electronic banking environment. Therefore, the service identifier for the service under consideration is presented in the electronic banking environment upon initiation of an electronic banking application (or upon initiation of a channel associated with an electronic banking application, e.g., a ‘Banking Center’ channel), and an account holder of the account may select the identifier using any acceptable form of input in order to use the service.

If the account has not previously used the service during the predetermined period as represented at block 204, the apparatus determines whether the account qualifies for the service as represented at block 212.

As represented at block 212, the apparatus subsequently determines whether the account is eligible for participating in the service (e.g., whether the account qualifies for the service). The factors that allow the apparatus to make this determination have been described previously. In some embodiments, this determination of eligibility is made dynamically in real-time, or in substantially real-time, e.g., a short delay of few seconds (e.g., thirty seconds) or few minutes (e.g., two or three minutes).

If the apparatus determines that the account is not eligible for participating in the service, then the apparatus does nothing (block 220). This means that the apparatus retains the status quo in the electronic banking environment. Therefore, in some embodiments, the status quo includes not presenting the service identifier for the service under consideration in the electronic banking environment upon initiation of an electronic banking application. In an alternate embodiment, the status quo includes presenting or displaying the service identifier in the electronic banking environment, but not allowing the service identifier to be selected by the account holder, e.g., the account holder cannot select the service by clicking the identifier, touching the identifier, or otherwise selecting the service identifier by any form of input. In some embodiments, an error message may be displayed in a pop-window when an account holder attempts to select the identifier.

If the apparatus determines that the account qualifies for the service, that means that an identifier for the service under consideration is presented in the electronic banking environment (block 224), and an account holder of the account may select the identifier using any acceptable form of input in order to use the service. Additionally or alternatively, the apparatus activates the banking service for the account, e.g., in some embodiments, the apparatus enrolls the account to use the banking service when the account holder selects the identifier. In alternate embodiments, an apparatus may provide a separate identifier that enables the account holder to enroll in the service.

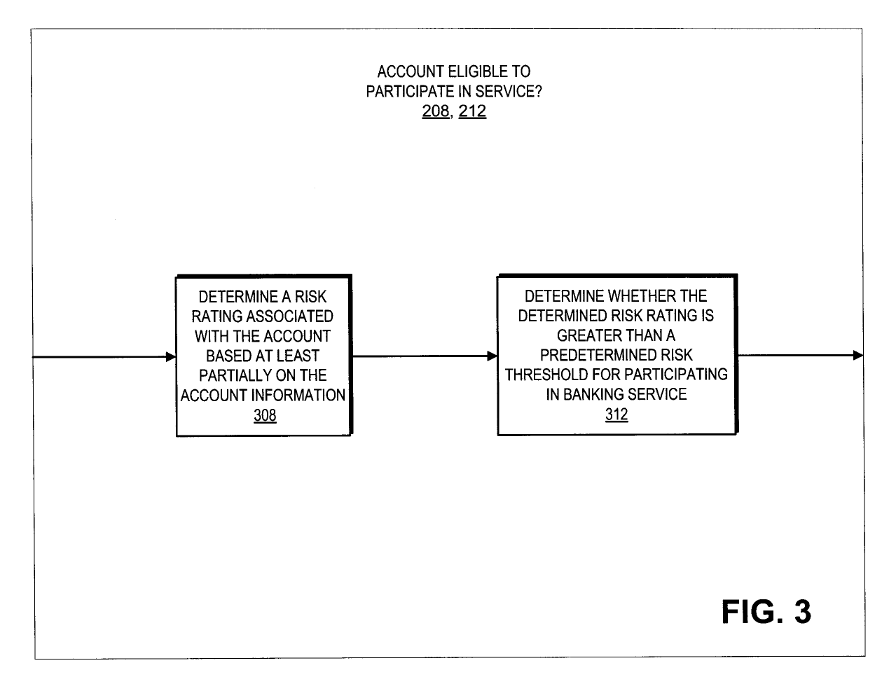

Referring now to FIG. 3, a process flow is provided that is an expansion of blocks 208 and 212 of FIG. 2. In some embodiments, the process flow in FIG. 3 is performed by an apparatus having hardware and/or software configured to perform one or more portions of the process flow 100, 200, and/or 400. In some of these embodiments, the apparatus having the process flow 100, 200, and/or 400 includes a banking apparatus 1330 and a remote capture device 1320.

In order to determine whether a risk pattern exists for an account, in some embodiments, the apparatus may be configured to consider one or more of the above pieces of account information, e.g., account data, received at block 110 of FIG. 2. In such embodiments, the apparatus may determine that a risk pattern exists for an account solely on the basis of one or more of the above pieces of account information, without engaging in any further calculations. For instance, the apparatus may consider the period of time for which the account has been open. In some embodiments, the apparatus may also consider any financial obligation associated with the account (e.g., a fees or fine associated with an account) in determining whether a risk pattern exists. In some embodiments, the apparatus may consider the frequency and type of transactions associated with an account. In some embodiments, the events associated with an account that are considered are those that occurred since the account holder's previous initiation of the banking application.

In other embodiments, the apparatus may be configured to calculate a risk rating (block 308 of FIG. 3) after determining one or more risk patterns for an account. Therefore, in some embodiments of block 308 of FIG. 3, the apparatus, in some embodiments, may automatically calculate a risk rating associated with an account. In order to calculate the risk rating associated with the account, the apparatus may first identify, using a processor, one more risk patterns associated with the account under consideration. The apparatus may then dynamically assign a weightage to each of the different identified risk patterns. The weightage associated with a risk pattern for one account may be different from the weightage associated with the risk pattern for another account. The apparatus then plugs these risk pattern weightages into a risk rating formula. The risk rating formula that is used by the apparatus may vary from one account to another account, from one service to another service, etc. The apparatus is then configured to compare the calculated risk rating to a threshold risk rating (block 312 of FIG. 3). The threshold risk rating may also vary from one account to another account, from one service to another service, etc. If the calculated risk rating is greater than the threshold rating, the account is not eligible to participate in the service, e.g., the account does not qualify for the service. If the calculated risk rating is smaller than the threshold rating, the account is eligible to participate in the service, e.g., the account qualifies for the service. In some embodiments, the risk rating calculated at block 308 is an updated risk rating for the account that is attempting to access a service (e.g., mobile deposit service). A risk rating may have been previously calculated for the account when the account previously attempted to access and/or use the service.

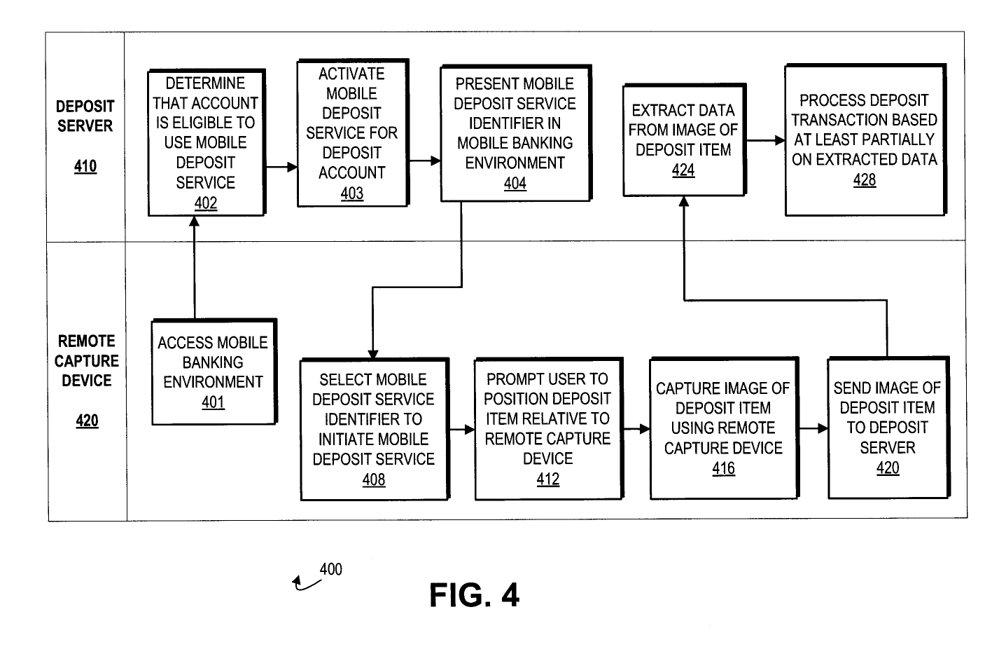

Referring now to FIG. 4, a flowchart 400 is provided for processing a deposit of a deposit item that is made via a remote capture device 420, in accordance with some embodiments of the invention. In some embodiments, the process flow 400 is performed by an apparatus having hardware and/or software configured to perform one or more portions of the process flow 100 and 200. In some of these embodiments, the apparatus having the process flow 400 includes a deposit server 410 and a remote capture device 420. The term “deposit,” as used herein, generally refers to the process of depositing a deposit item (and/or the funds and/or credit corresponding thereto) into an account associated with the account holder. The phrase “deposit item,” as used herein, generally refers to one or more checks (e.g., personal checks, business checks, cashier's checks, credit card convenience checks, certified checks, pay checks, traveler's checks, etc.), money orders, deposit slips, payment vouchers, and/or the like. In some embodiments, the “deposit item” refers to two or more deposit items and/or to two or more different types of deposit items.

At block 401, the account holder accesses a mobile banking environment. In some embodiments, this means that the account holder executes a mobile deposit application on the remote capture device 420. For example, in some embodiments, the remote capture device 420 is an iPhone®, and the mobile deposit application is an “app” that executes on the iPhone® for initiating, executing, completing, and/or otherwise facilitating a deposit transaction involving the remote capture device 420. In some embodiments, the mobile banking application requires the account holder to identify and/or authenticate himself. For example, in some embodiments, the account holder must provide a username/password, personal identification number (PIN), smart card, token (e.g., USB token, etc.), biometric information, and/or some other information, device, and/or credential to the remote capture device 420 prior to that device granting the account holder access to the application.

Thereafter, as represented by block 402, the deposit server 410 determines whether the account (e.g., deposit account) associated with the account holder is eligible to use the mobile deposit application (e.g., whether the account qualifies for the service). Thereafter, as represented by block 403, the deposit server 410 is configured to activate the mobile deposit service for the account holder's deposit account. Thereafter, as represented by block 404, the deposit server 410 is configured to display an identifier in a mobile banking environment associated with a deposit account. This identifier allows an account holder to deposit a deposit item via a remote capture device 420 into a banking account. Therefore, the identifier is associated with a mobile deposit application.

Thereafter, as represented by block 408, the account holder selects the identifier on the remote capture device 420 to initiate the mobile deposit service. As described previously, when an account holder selects the identifier using any acceptable form of input (mouse-over input, touch screen input, a button input, a mouse click input, a keyboard input, a voice command input, or the like), an application (e.g., a service application such as a mobile deposit application) is executed on a computing device (e.g., a mobile computing device).

As represented by block 412, the remote capture device 420 may be configured to prompt the account holder to position the frontal surface of the deposit item such that the deposit item is exposed to the remote capture device 420. In some embodiments, this means that the account holder is prompted to position the deposit item on a flat surface, and/or position the deposit item such that the remote capture device 420 is positioned orthogonally with respect to the deposit item, and/or position the deposit item such that all four corners of the deposit item are captured, and/or position the deposit item such that the front surface of the deposit item is illuminated by adequate lighting, etc. In some embodiments, the account holder is prompted to position the remote capture device 420 proximate and/or relative to the deposit item, such that light from the deposit item is physically received by the remote capture device 420. For example, in some embodiments, the remote capture device 420 includes a photographic lens and an image sensor, and the image sensor is configured to generate an image of the deposit item based at least partially on light from the deposit item passing through the lens, reaching the image sensor, and being converted into electrical signals by the image sensor. It will be understood that the remote capture device 420 can be configured to generate one or more still images of the deposit item and/or a series of video images of the deposit item.

Once the frontal surface of the deposit item is positioned by the account holder, in some embodiments, the remote capture device 420, as represented by block 416, may be configured to allow the account holder to execute an act (such as clicking on, pressing, or otherwise selecting a digital button, a physical button, or the like) such that the remote capture device 420 captures as image of the frontal surface of the deposit item. In another embodiment, the remote capture device 420 may automatically capture an image of the front surface of the deposit item once the remote capture device 420 determines that the front surface of the deposit item is appropriately exposed to the remote capture device 420. In some embodiments, the remote capture device 420 “capturing” the image generally means that the remote capture device 420 stores the image of the deposit item in the memory of the remote capture device 420. In some embodiments, this memory is non-temporary, non-volatile, and/or long-term persistent memory. Additionally or alternatively, in some embodiments, the image is captured if an account holder of the remote capture device 420 can retrieve the image from the memory of the remote capture device 420 sometime after the deposit item is exposed to the remote capture device 420. Of course, it will be understood that the remote capture device 420 may not capture every image that it generates. For example, in some embodiments, the remote capture device 420 discards and/or erases generated images that are not captured. However, in other embodiments, the remote capture device 420 does not discard or erase generated images that are not captured, but instead identifies and/or stores them differently. For example, in some embodiments, the remote capture device 420 stores generated but not captured images in temporary and/or volatile memory, whereas the remote capture device 420 stores captured images in non-temporary, non-volatile, and/or long-term persistent memory. In some embodiments, the remote capture device 420 may repeat blocks 412 and 416 for the back surface of the deposit item. Thereafter, as represented by block 420, the remote capture device 420 transmits the image (e.g., via a wireless network, via the Internet, etc.) to the deposit server 410.

Thereafter as represented by block 424, the deposit server 410 receives the image of the deposit item (in some embodiments, both front and back images of the deposit item). The deposit server 410 subsequently extracts data from this image. For instance, the deposit server 410 may extract the routing data, the account data, the serial data associated with the deposit item, etc. In an embodiment where the deposit server 410 is a check, the deposit server 410 is configured to read the payee name, the payor financial institution, one or more MICR lines, and/or the written and/or numerical check amount from the image of the check.

Thereafter as represented by block 428, the deposit server 410 processes the deposit item. In some embodiments, the processing step includes crediting the account associated with the account holder, where the amount of the credit equal to the amount of the deposit item (or sending an instruction to another system to credit the account holder's account). In some embodiments, an account is not instantly credited when making a deposit via a remote capture device 420. In some embodiments, a processing fee may be deducted from the amount of the deposit item.

FIGS. 5-12 illustrate example screenshots of the electronic banking environment associated with a banking account. For the screenshots presented in FIGS. 5-12, the electronic banking environment is a graphical user interface associated with a mobile banking account. The screenshots discussed below with respect to various process blocks are mere examples of screenshots in some embodiments of the invention. In other embodiments of the invention, the screenshots may include additional features not described herein, or may not include each and every feature described herein. As used with respect to the various screenshots of FIGS. 5-12, an “apparatus” may either be a banking apparatus 1330 or a remote capture device 1320. The apparatus may generate the screenshots presented in FIGS. 5-12 and may cause the presentation of one or more elements in each screenshot presented in FIGS. 5-12.

FIG. 5 presents a screenshot of a homepage of a mobile banking account. This apparatus presents this screenshot after an account holder has been authenticated into the mobile banking account. The screenshot in FIG. 5 presents various channels 510 that an account holder may access. For instance, the various account channels are ‘Personal,’ Banking Center,' and ‘Small Business.’

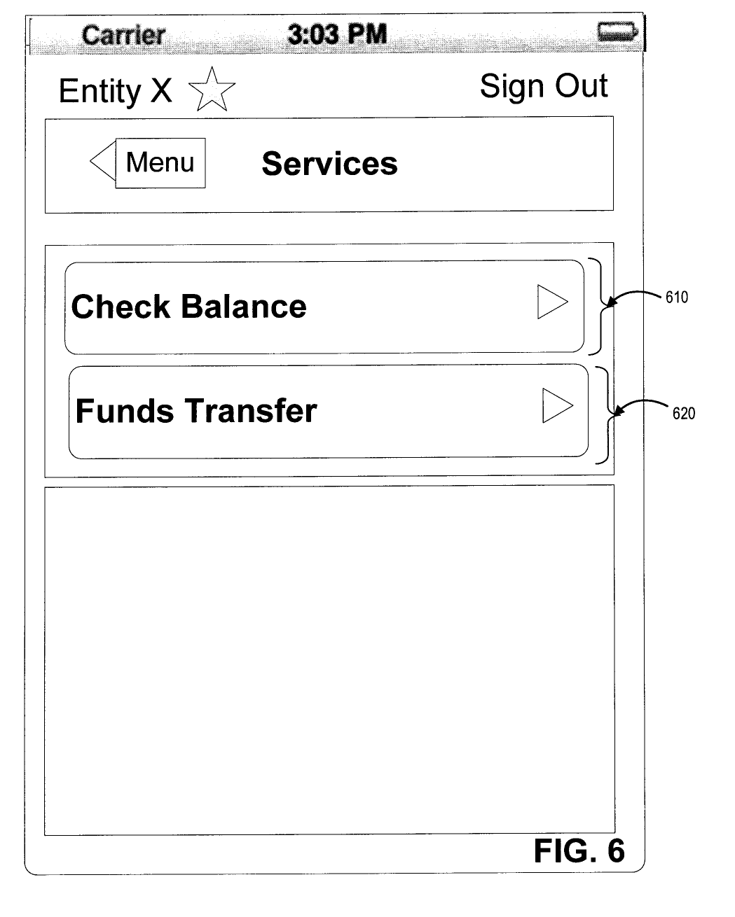

As shown in FIG. 6, when the account holder selects the ‘Banking Center’ channel of FIG. 5, the account holder is directed to a page that includes two service identifiers: ‘Check Balance,’ 610 and ‘Funds Transfer’ 620. In some embodiments, upon an account holder's selection of the ‘Banking Center’ channel, an apparatus determined that the account was eligible to participate in the ‘Check Balance’ and ‘Funds Transfer’ services. As described previously, this determination is made in substantially real-time. This may mean that the determination was made instantly upon an account holder's selection of the ‘Banking Center’ channel. In other embodiments, this may mean that the determination was made a short duration after the account holder's selection of the ‘Banking Center’ channel. In some embodiments, this duration may be few seconds (e.g., thirty seconds) or few minutes (e.g., two or three minutes). Therefore, in some embodiments, there may be a slight delay from the moment an account holder selects the ‘Banking Center’ channel to the moment the service identifiers appear on the mobile application interface (FIG. 6).

In another embodiment, upon initiation of the mobile banking application (e.g., FIG. 5), an apparatus determined that the account was eligible to participate in the ‘Check Balance’ and ‘Funds Transfer’ services. Again, this determination may have been made in substantially real-time. This may mean that the determination was made instantly upon an account holder's initiation of the mobile banking application. In other embodiments, this may mean that the determination was made a short duration after the account holder's initiation of the mobile banking application. In some embodiments, this duration may be few seconds (e.g., thirty seconds) or few minutes (e.g., two or three minutes). Additionally, in both embodiments, the apparatus may have determined that the account was not eligible to participate in one or more services; therefore, the apparatus does not display identifiers associated with those services in the electronic banking environment (e.g., on the graphical user interface/mobile application interface).

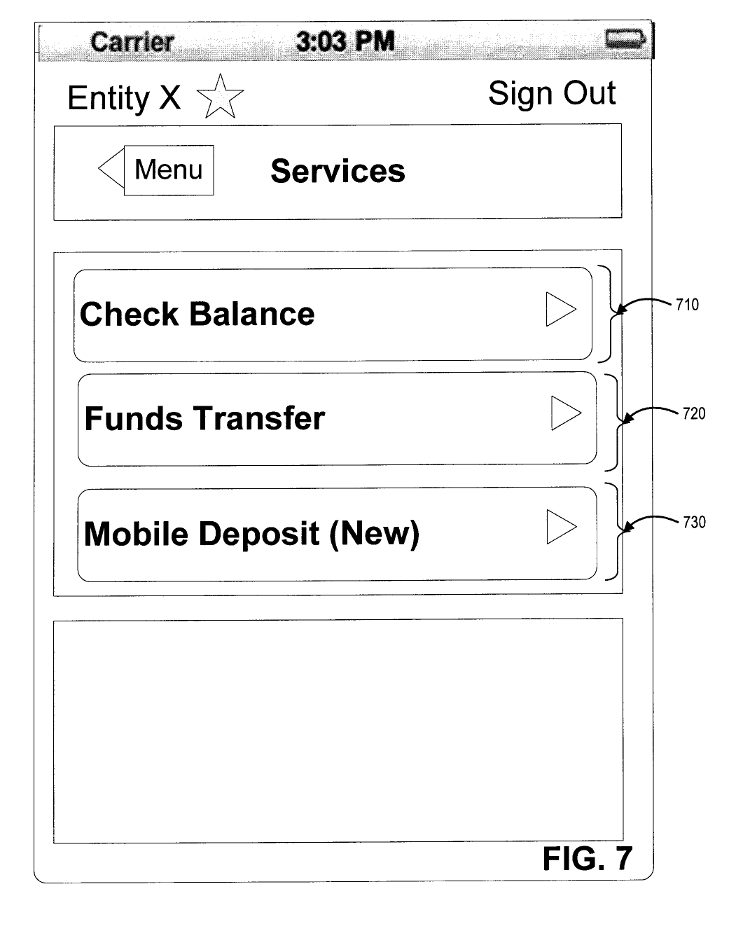

As shown in FIG. 7, when the account holder selects the ‘Banking Center’ channel of FIG. 5, the account holder is directed to a page that includes three service identifiers: ‘Check Balance,’ 710 ‘Funds Transfer,’ 720 and ‘Mobile Deposit’ 730. This means that the account is eligible to participate in each of these three services. These services are presented merely as examples and the invention is not limited to these services. The process that dictates which service identifiers are displayed on the mobile application interface has been described earlier with respect to FIG. 6. If the account holder has previously not used the ‘Mobile Deposit’ service within a predetermined period in the past, the mobile application interface indicates that the service is a ‘new’ service that is added to the account. Additionally, the mobile application interface may display a ‘Click to Enroll’ a message as well since the account has not previously used the service within a predetermined period in the past. If the account holder has previously used the ‘Mobile Deposit’ service within a predetermined period in the past, the mobile application interface may not indicate that the service is a ‘new’ service. Rather than a ‘Click to Enroll’ message, the mobile application interface may display a ‘Click to Use’ message.

As shown in FIG. 8, when the account holder selects the ‘Banking Center’ channel of FIG. 5, the account holder is directed to a page that includes three service identifiers: ‘Check Balance,’ 810 ‘Funds Transfer,’ 820 and ‘Mobile Deposit’ 830. However, the mobile application interface indicates to an account holder that that the account is eligible to participate only in the ‘Check Balance’ and ‘Funds Transfer’ services. The mobile application interface indicates to the account holder that the ‘Mobile Deposit’ service has been deactivated with respect to the account. Therefore, although an identifier associated with the ‘Mobile Deposit’ service is displayed on the mobile application interface, the account holder cannot select the identifier. The mobile application interface indicates to the account holder that the account holder can call the presented phone number to understand the reasons why the service was deactivated or to learn about any possible steps for reactivating the ‘Mobile Deposit’ service.

In some embodiments, the interface displayed in FIG. 8 is presented only when an account has previously used the ‘Mobile Deposit’ service within a predetermined period in the past. If the account has not used the ‘Mobile Deposit’ service within a predetermined period in the past and the account is not eligible to participate in the ‘Mobile Deposit’ service, the mobile application interface will resemble FIG. 6 (e.g., there is no indication to the account holder that the ‘Mobile Deposit’ service is not activated for an account). In some embodiments, the interface displayed in FIG. 8 is presented regardless of whether or not the account has used the ‘Mobile Deposit’ service within a predetermined period in the past as long as the account is not eligible to participate in the service.

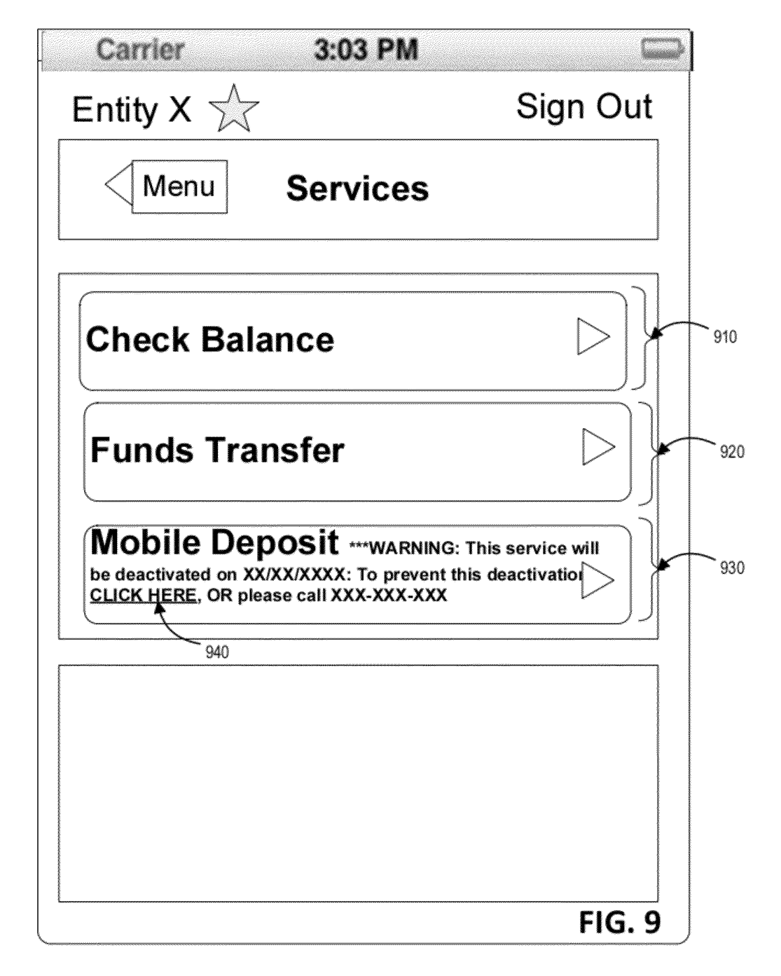

FIG. 9 is a slight modification over FIG. 8. In FIG. 8, an apparatus determines that an account is not eligible to participate in a service, and presents a deactivated service identifier on a mobile application interface. In FIG. 9, an apparatus determines that an account is not eligible to participate in a service, and presents on a mobile application interface a service identifier that can be selected by the account holder; however, the apparatus also indicates to an account holder that the service will be deactivated with respect to the account on a certain terminating date. Therefore, as shown in FIG. 9, when the account holder selects the Banking Center' channel of FIG. 5, the account holder is directed to a page that includes three service identifiers: ‘Check Balance,’ 910 ‘Funds Transfer,’ 920 and ‘Mobile Deposit’ 930. The mobile application interface indicates to an account holder that that the account is eligible to participate in the ‘Check Balance’ and ‘Funds Transfer’ services. The mobile application interface indicates to the account holder that the account may also participate in the ‘Mobile Deposit’ until a certain terminating date. The mobile application interface indicates to the account holder that the account holder can call the presented phone number to understand the reasons why the ‘Mobile Deposit’ service will be deactivated or to learn about any possible steps for preventing the deactivation of the ‘Mobile Deposit’ service.

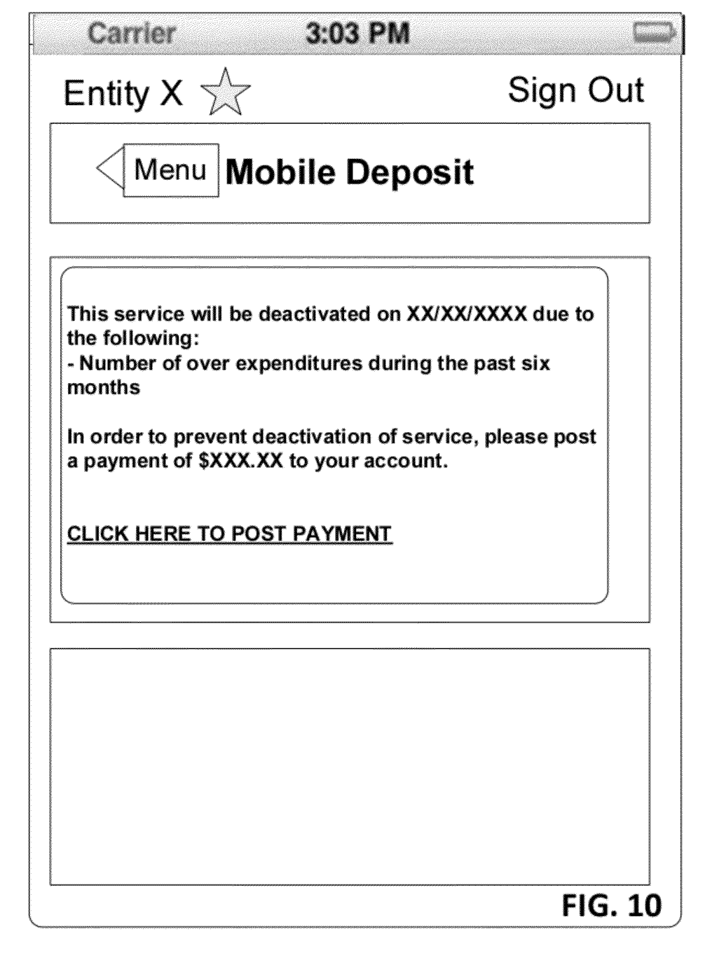

FIG. 9 also displays a ‘CLICK HERE’ 940 option, which allows an account holder to take steps to prevent the deactivation of ‘Service C’. By selecting the ‘CLICK HERE’ option, the account holder is directed to the mobile application interface page presented in FIG. 10. The invention is not limited to the embodiment described herein for the manner in which the mobile application interface indicates to the account holder that that the account holder may take steps to prevent the deactivation of the ‘Mobile Deposit’ service. For instance, in an alternate embodiment, the ‘CLICK HERE’ option may be presented on a pop-up window. In another embodiment, the application may not even present a ‘CLICK HERE’ option; instead, the application may forward the account holder to the interface displayed in FIG. 10 when an account holder selects the ‘Mobile Deposit’ service identifier.

FIG. 10 is an embodiment of a page presented by the banking application, where the page informs the account holder of the reason(s) why ‘Mobile Deposit’ will be deactivated on a particular terminating date in the future. For instance, in the example shown in FIG. 10, the event that is the cause for the impending deactivation of the service is the number of overdrafts associated with the account during the previous six months. In another embodiment, a different event may be the reason why the service will be deactivated. For instance, an alternate reason may be that a balance associated with the account has fallen below a certain level. As a further instance, an alternate reason may be a new negative event on a credit report associated with the holder of the account. In other embodiments, the reason for the impending deactivation of the ‘Mobile Deposit’ service could be a combination of one or more reasons. In such a case, each reason may be presented on the mobile application interface. In some embodiments, an event that is the cause for the impending deactivation occurs between a previous initiation of the mobile banking application and a current initiation of the mobile banking application.

As shown in FIG. 10, the apparatus also presents a remedial procedure, which, if executed by an account holder, would prevent the deactivation of the ‘Mobile Deposit’ service with respect to an account. As indicated in FIG. 10, the remedial procedure directs the account holder to post a payment to an account in order for the account to have continued eligibility to access the ‘Mobile Deposit’ service. The amount of payment may be dynamically generated by the apparatus, such that the amount of payment to be posted for one account may be different from the amount of payment to be posted by another account. The invention is not limited to the remedial actions described herein. For instance, in another embodiment, a remedial action may include the mobile application interface recommending the account holder to add a guarantor to the account, or to change an address associated with the account, or to pay a fee for continued usage of the ‘Mobile Deposit’ service past the terminating date, etc. In such an embodiment, the mobile application interface may direct the account holder to another interface page where the account holder may pay a fee (e.g., payment via a payment card, debit from account holder's account, etc.).

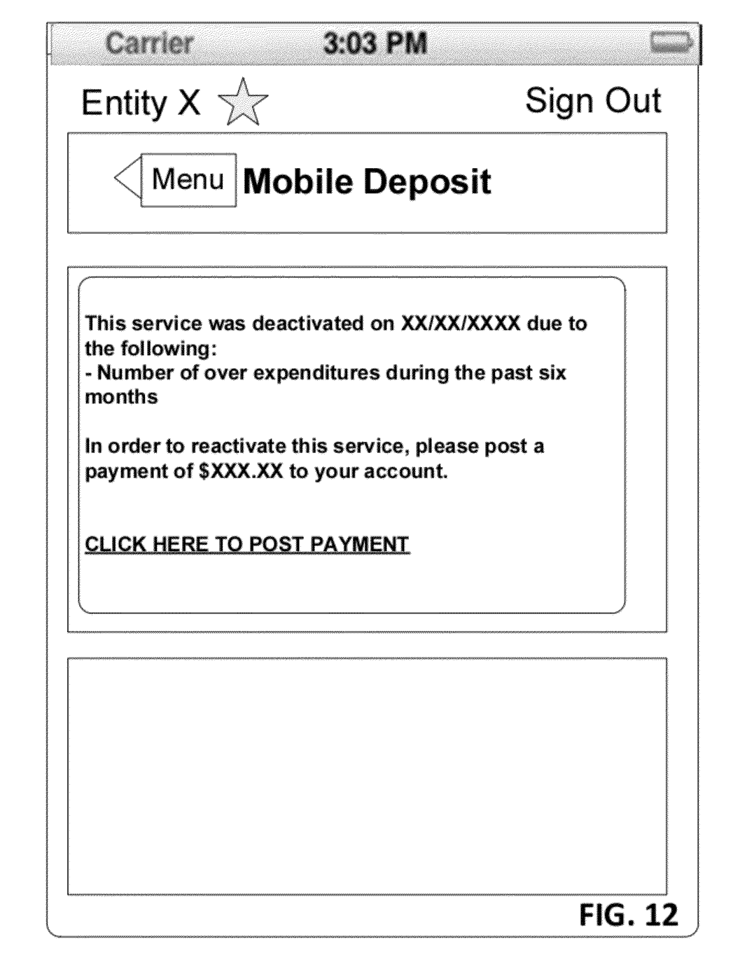

FIGS. 11 and 12 are similar to FIGS. 9 and 10. In FIGS. 9 and 10, the mobile application interface indicates to the account holder that the ‘Mobile Deposit’ service will be deactivated on a terminating date in the future. In FIGS. 11 and 12, the ‘Mobile Deposit’ service is deactivated at the moment when the account holder selects the ‘Banking Center’ channel or is deactivated prior to when the account holder selects the ‘Banking Center’ channel, e.g., when the banking application is initiated.

Referring now to FIG. 13, a system 1300 is provided for determining that an account is eligible to participate in a banking service, in accordance with an embodiment of the present invention. As illustrated, the exemplary system 1300 includes a network 1310, a remote capture device 1320, and a banking apparatus 1330. Also shown are a remote capture device user 1305 and an image 1307 that shows the deposit item, which in the presented embodiment is a check 1301. It will be understood that the check 1301 includes the deposit amount 1311 of $25, and that the check 1301 also includes deposit item information that is not shown (e.g., information associated with a payee identity, an account number, a MICR line, etc.). Also, it will be understood that the remote capture device user 1305 (e.g., the account holder) has access to the remote capture device 1320 and to the check 1301.

In some embodiments, the user 1305 can view, receive, generate, create, acquire, and/or capture the image 1307 by using the remote capture device 1320. In other embodiments, the remote capture device 1320 views, receives, generates, and/or captures the image 1307 automatically (e.g., without the user's 1305 intervention). In addition, in some embodiments, the remote capture device 1320 is exposed to and/or located proximately to the check 1301 when the image 1307 is viewed, received, generated, and/or captured by the remote capture device 1320. Also, in accordance with some embodiments, the remote capture device 1320 is located remotely from the banking apparatus 1330.

In addition, it will be understood that, in this example embodiment, the user 1305 intends to deposit the sum of the deposit amount 1311 (i.e., $25) into the checking account 1309. Also, the checking account 1309 is held by the user 1305 and is maintained by a bank or financial institution (not shown) for the benefit of that user 1305, who is a customer of that bank or financial institution. Still further, it will be understood that, in this example embodiment, the remote capture device 1320 is maintained by the remote capture device user 1305, and that the banking apparatus 1330 is maintained by the same bank that maintains the checking account 1309. In another embodiment, the checking account may be any other type of banking account associated with the financial institution.

As shown in FIG. 13, the remote capture device 1320 and the banking apparatus 1330 are each operatively and selectively connected to the network 1310, which may include one or more separate networks. In addition, the network 1310 may include one or more interbank networks, telephone networks, telecommunication networks, satellite networks, local area networks (LANs), wide area networks (WANs), and/or global area networks (GANs) (e.g., the Internet, etc.). It will also be understood that the network 1310 may be secure and/or unsecure and may also include wireless and/or wireline technology.

The remote capture device 1320 can include any remote capture device described and/or contemplated herein. In addition, the remote capture device 1320 can initiate, execute, complete, and/or otherwise facilitate any one or more portions of any embodiment described and/or contemplated herein. In some embodiments, the remote capture device 1320 includes one or more mobile phones, gaming devices, digital cameras, flatbed scanners, tablet computers, and/or the like. As illustrated in FIG. 13, the remote capture device 1320 includes a communication interface 1322, a processor 1324, a memory 1326 having a remote capture application 1327 stored therein, an image capture device 1328, a user interface 1329, a positioning system device 1331, etc. In such embodiments, the processor 1324 is operatively and selectively connected to the communication interface 1322, the user interface 1329, the image capture device 1328, the memory 1326, and the positioning system device 1331.

Each communication interface described herein, including the communication interface 1322, generally includes hardware, and, in some instances, software, that enables a portion of the system 1300, such as the remote capture device 1320, to send, receive, and/or otherwise communicate information to and/or from the communication interface of one or more other portions of the system 1300. For example, the communication interface 1322 of the remote capture device 1320 may include a modem, network interface controller (NIC), network adapter, network interface card, and/or some other electronic communication device that operatively connects the remote capture device 1320 to another portion of the system 1300, such as, for example, the banking apparatus 1330.

Each processor described herein, including the processor 1324, generally includes circuitry for implementing the audio, visual, and/or logic functions of that portion of the system 1300. For example, the processor may include a digital signal processor device, a microprocessor device, and/or various analog-to-digital converters, digital-to-analog converters, and/or other support circuits. Control and signal processing functions of the apparatus in which the processor resides may be allocated between these one or more devices according to their respective capabilities. The processor may also include functionality to operate one or more software programs based at least partially on computer-executable program code portions thereof, which may be stored, for example, in a memory device, such as in the remote capture application 1327 of the memory 1326 of the remote capture device 1320.

Each memory device described herein, including the memory 1326 for storing the remote capture application 1327 and/or other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus. The memory may be non-transitory or transitory.

As shown in FIG. 13, the memory 1326 includes the remote capture application 1327. The remote capture application 1327 may instruct and/or cause the processor 1324 (and/or one or more other portions of the remote capture device 1320) to perform any one or more of the functions described herein as being performed by “a remote capture device,” by the remote capture device 1320, and/or by the remote capture application 1327. Additionally or alternatively, the remote capture application 1327 can be executable to initiate, execute, complete, and/or otherwise facilitate any one or more portions of any embodiment described and/or contemplated herein, such as, for example, any one or more portions of the process flows 100, 200, or 400 described herein.

For example, in some embodiments, the remote capture application 1327 is executable to receive and/or generate an image (e.g., the image 1307, etc.) that shows a deposit item (e.g., the check 1301, etc.). In some embodiments, the remote capture application 1327 is executable to determine, automatically or otherwise, whether an image (e.g., the image 1307, etc.) is satisfactory (e.g., passes a minimum threshold of clarity) for reading deposit item information from the image (e.g., the deposit amount 1311 of $25, etc.). In still other embodiments, the remote capture application 1327 is executable to perform, automatically or otherwise, any one or more of the actions represented by blocks of process flow 100, 200, or 400. As another example, in some embodiments, the remote capture application 1327 is executable to automatically capture an image of a deposit item using the image capture device 1328, or prompt a user to initiate a process to capture an image of a deposit item using the image capture device, and to determine whether the image of the deposit item is satisfactory in order to obtain data from the deposit item. As still another example, in some embodiments, the remote capture application 1327 is additionally or alternatively executable to credit an account (e.g., the account 1309, etc.) based at least partially on the deposit item information associated with the deposit item.

In some embodiments, the remote capture application 1327 is additionally or alternatively executable to perform one or more functions other than those previously described herein. For example, in some embodiments, the remote capture application 1327 is executable to require the user 1305 to identify and/or authenticate himself/herself to the remote capture application 1327 before the remote capture application 1327 will initiate, execute, complete, and/or otherwise facilitate any of the functions described and/or contemplated herein. For example, in some embodiments, the remote capture application 1327 is executable to identify and/or authenticate the user 1305 based at least partially on an username/password, personal identification number (PIN), smart card, token (e.g., USB token, etc.), biometric information, and/or some other information, device, and/or credential that the user 1305 provides to the remote capture application 1327. Additionally or alternatively, in some embodiments, the remote capture application 1327 is executable to identify and/or authenticate the user 1305 by using one-, two-, or multi-factor identification and/or authentication. For example, in some embodiments, the remote capture application 1327 requires two-factor authentication, such that the remote capture device user 1305 must provide the correct smart card and enter the correct PIN in order to authenticate the user 1305 to the remote capture application 1327.

It will also be understood that, in some embodiments, the remote capture application 1327 is executable to enable the remote capture device user 1305 and/or the remote capture device 1320 to communicate with one or more other portions of the system 1300, and/or vice versa. In some embodiments, the remote capture application 1327 is executable to access an electronic banking service (e.g., online banking, mobile banking, SMS banking, etc.). Further it will be understood that, in some embodiments, the remote capture application 1327 is created, provided, controlled, and/or maintained by the bank that maintains the banking apparatus 1330 and/or by an individual or business (not shown). For example, in some embodiments, the remote capture device 1320 is embodied as an iPhone®, and the remote capture application 1327 is embodied as an “app” that was created by a bank and/or by a software maker for execution on the iPhone®. Also, it will be understood that, in some embodiments, the remote capture application 1327 includes one or more computer-executable program code portions for instructing the processor 1324 to perform one or more of the functions of the remote capture application 1327 and/or of the remote capture device 1320 described and/or contemplated herein. In some embodiments, the remote capture application 1327 may include and/or use one or more network and/or system communication protocols.

Also shown in FIG. 13 is the image capture device 1328, which may include one or more cameras (e.g., digital or otherwise, etc.), charge coupled devices (CCD), complementary metal-oxide-semiconductor (CMOS) sensors, image sensors, and/or the like, including any one or more of the image capture devices described and/or contemplated herein. The image capture device 1328 may include one or more different types of image capture devices. In some embodiments, the image capture device 1328 is configured to receive, detect, recognize, and/or capture optical light, ultraviolet light, and/or infrared light. In some embodiments, the image capture device 1328 can be configured to view, receive, acquire, generate, create, and/or capture one or more still images and/or videos. In some embodiments, the image capture device 1328 is configured to communicate one or more generated and/or captured images to the processor 1324. Additionally or alternatively, in some embodiments, the image capture device 1328 includes one or more features, including, but not limited to, a zoom, focus, flash, lens, shutter, viewfinder, and/or the like. In some embodiments, the image capture device 1328 has a resolving power, which, for example, defines the detail and/or resolution with which an image can be generated and/or captured by the image capture device 1328.

In some embodiments, the resolving power associated with the image capture device 1328 is measured in the number of pixel sensors (sometimes referred to merely as “pixels”) used by the image capture device 1328 in order to capture the image. In some embodiments, the image capture device 1328 is housed in the remote capture device 1320. However, in other embodiments, the image capture device 1328 is operatively connected to the remote capture device 1320 but is not housed in the remote capture device 1320; instead, in such embodiments, the image capture device 1328 is located adjacent, near, within arm's reach, and/or otherwise proximate to the remote capture device 1320 (e.g., a peripheral digital camera plugged into a mobile phone, etc.).

It will also be understood that the remote capture device 1320 also includes the user interface 1329. It will be understood that the user interface 1329 (and any other user interface described and/or contemplated herein) can include and/or be embodied as one or more user interfaces. In some embodiments, the user interface 1329 includes one or more user output devices for presenting (e.g., communicating, rendering, displaying, outputting, etc.) information to the user 1305, such as, for example, one or more displays, speakers, and/or the like. In some embodiments, the user interface 1329 additionally or alternatively includes one or more user output devices for presenting information to the remote capture device user 1305. In some embodiments, the user interface 1329 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, scanners, biometric readers, motion detectors, cameras, and/or the like for receiving information from one or more items (e.g., the check 1301, etc.) and/or the remote capture device user 1305. In some embodiments, the user interface 1329 is housed in the remote capture device 1320. However, in other embodiments, the user interface 1329 is operatively connected to the remote capture device 1320 but is not housed in the remote capture device 1320; instead, in such embodiments, the user interface 1329 is located adjacent, near, within arm's reach, and/or otherwise proximate to the remote capture device 1320 (e.g., a peripheral touchscreen display plugged into a digital camera, etc.).

In some embodiments, the remote capture device 1320 includes a positioning system device 1331 that is configured to be used by the banking apparatus 1330 to determine a location associated with the remote capture device 1320. For example, the positioning system device 1331 may include a global positioning system (GPS) transceiver that communicates with a GPS satellite. The banking apparatus 1330 may be able to receive GPS coordinates associated with the remote capture device by communicating with the GPS satellite.

In some embodiments, the positioning system device 1331 is at least partially made up of an antenna, a transmitter, and a receiver. In some embodiments, triangulation of cellular signals may be used to identify the approximate location of the remote capture device 1320. For instance, the banking apparatus 1330 may be able to identify a cell site, e.g., cell tower that is located close to or closest to the remote capture device 1320. As a further instance, the banking apparatus 1330 may be able to identify a cell site that is communicating with the remote capture device 1320, even though the cell site is not the closest cell site to the remote capture device 1320.

In other embodiments, the positioning system device 1331 includes a proximity sensor or transmitter, such as an RFID tag, that can sense or be sensed by devices known to be located proximate a merchant or other location to determine that the remote capture device 1320 is located proximate these devices. The banking apparatus 1330 may then communicate with these devices to determine the location of the remote capture device 1320.

In some embodiments where the remote capture device 1320 is on a network, the banking apparatus 1330 can identify or receive a network address associated with the remote capture device 1320. In some embodiments, the banking apparatus 1330 may receive the network address by either ‘pinging’ the remote capture device or some other system on the network that retains information about one or more devices on the network. In some embodiments, the network address is an Internet Protocol (IP) address.

FIG. 13 also illustrates the banking apparatus 1330. In some embodiments, the banking apparatus 1330 may include one or more servers, mainframes, engines, network devices, front end systems, back end systems, and/or the like. In some embodiments, such as the one illustrated in FIG. 13, the banking apparatus 1330 includes a communication interface 1332, a processor 1334, and a memory 1336, which includes a deposit application 1337, a pre-qualification application 1339, and an account datastore 1338 stored therein. As shown, the communication interface 1332 is operatively connected to the processor 1334, which is operatively connected to the memory 1336. In some embodiments, the banking apparatus 1330 may be a deposit server, or may include a deposit server.

The pre-qualification application 1339 may instruct and/or cause the processor 1334 (and/or one or more other portions of the banking apparatus 1330) to perform any one or more of the functions described herein as being performed by the banking apparatus 1330, and/or by the pre-qualification application 1339. Additionally or alternatively, the pre-qualification application 1339 can be executable to initiate, execute, complete, and/or otherwise facilitate any one or more portions of any embodiment described and/or contemplated herein, such as, for example, any one or more portions of the process flow 100, 200, or 400 described herein.

For example, in some embodiments, the pre-qualification application 1339 is executable to receive information associated with the account 1309. This information may include the above-described financial institution data and non-financial institution data associated with the account 1309 or associated with the account holder. As another example, in some embodiments, the pre-qualification application 1339 is additionally or alternatively executable to determine based at least partially on the received information, that the account 1309 is eligible to participate in a banking service. As another example, in some embodiments, the pre-qualification application 1339 is additionally or alternatively executable to present, in an electronic banking environment, an identifier associated with the banking service. As another example, in some embodiments, the pre-qualification application 1339 is additionally or alternatively executable to perform the determining in substantially real time. In some embodiments, this may mean that the determining is performed instantly upon initiation of an electronic banking application. In other embodiments, this may mean that the determining is performed within a short period, e.g., few seconds (e.g., thirty seconds) or few minutes (e.g., two or three minutes) after initiation of an electronic banking application. As another example, in some embodiments, the pre-qualification application 1339 is additionally or alternatively executable to allow a user 1305 of the account 1309 to select the identifier to either use the banking service or enroll in the banking service. As another example, in some embodiments, the pre-qualification application 1339 is additionally or alternatively executable to remove the identifier from the electronic banking environment. As another example, in some embodiments, the pre-qualification application 1339 is additionally or alternatively executable to present a message that the identifier will be removed from the electronic banking environment on a terminating date. As another example, in some embodiments, the pre-qualification application 1339 is additionally or alternatively executable to recommend an action to prevent deletion of the identifier.

Additionally, in some embodiments, the pre-qualification application 1339 is additionally or alternatively executable to receive one or more risk determination rules associated with the account. As another example, the pre-qualification application 1339 is additionally or alternatively executable to determine, based at least partially on the received information and based at least partially on the risk determination rules, that the account 1309 is eligible to participate in a banking service. As another example, the pre-qualification application 1339 is additionally or alternatively executable to calculate a risk rating associated with the account. As another example, the pre-qualification application 1339 is additionally or alternatively executable to compare a risk rating associated with the account to a risk threshold rating associated with a banking service.

As used above with respect to the pre-qualification application 1339, the electronic banking environment may be a graphical user interface associated with the account 1309. The account may be an electronic banking account (e.g., online banking account, mobile banking account, etc.). In some embodiments, the banking service as used above with respect to the pre-qualification application 1339 is a service that allows a user of the account to deposit a deposit item via a remote capture device 1320 into the account. In some embodiments, the deposit item is a check 1301.

In some embodiments, the pre-qualification application 1339 can be configured to perform one or more of the same functions previously described herein as being performed by the remote capture application 1327 (and/or vice versa). In some embodiments, the pre-qualification application 1339 can be configured to perform one or more of the same functions previously described herein as being performed by the deposit application 1337 (and/or vice versa).

It will also be understood that, in some embodiments, the pre-qualification application 1339 is configured to enable the banking apparatus 1330 to communicate with one or more other portions of the system 1300, such as, for example, the account datastore 1338, the remote capture device 1320, other internal or external databases or systems that carry the above-described financial institution data and non-financial institution data, and/or vice versa. In some embodiments, the pre-qualification application 1339 includes one or more computer-executable program code portions for instructing the processor 1334 to perform one or more of the functions of the pre-qualification application 1339 and/or banking apparatus 1330 described and/or contemplated herein. In some embodiments, the pre-qualification application 1339 may include and/or use one or more network and/or system communication protocols.

The deposit application 1337 may instruct and/or cause the processor 1334 (and/or one or more other portions of the banking apparatus 1330) to perform any one or more of the functions described herein as being performed by “a deposit server,” by the banking apparatus 1330, and/or by the deposit application 1337. Additionally or alternatively, the deposit application 1337 can be executable to initiate, execute, complete, and/or otherwise facilitate any one or more portions of any embodiment described and/or contemplated herein, such as, for example, any one or more portions of the process flow 100, 200, or 400 described herein.

For example, in some embodiments, the deposit application 1337 is executable to receive an image that shows a deposit item (e.g., the image 1307 that shows the check 1301, etc.). As another example, in some embodiments, the deposit application 1337 is executable to read deposit item information (e.g., the deposit amount 1311, etc.) from a captured image. As another example, in some embodiments, the deposit application 1337 is additionally or alternatively executable to credit an account (e.g., the checking account 1309, etc.) based at least partially on the deposit item information associated with the deposit item. For example, in some embodiments, the deposit application 1337 is executable to transfer funds from a payor account identified in the deposit item information, in an amount identified in the deposit item information, and to a payee account identified in the deposit item information. In some embodiments, the deposit application 1337 can be configured to perform one or more of the same functions previously described herein as being performed by the remote capture application 1327 (and/or vice versa).

It will also be understood that, in some embodiments, the deposit application 1337 is configured to enable the banking apparatus 1330 to communicate with one or more other portions of the system 1300, such as, for example, the account datastore 1338 and/or the remote capture device 1320, and/or vice versa. It will further be understood that, in some embodiments, the deposit application 1337 is configured to initiate, execute, complete, and/or otherwise facilitate one or more financial transactions and/or to maintain one or more financial accounts (e.g., the checking account 1309, etc.) stored in the account datastore 1338. In some embodiments, the deposit application 1337 includes one or more computer-executable program code portions for instructing the processor 1334 to perform one or more of the functions of the deposit application 1337 and/or banking apparatus 1330 described and/or contemplated herein. In some embodiments, the deposit application 1337 may include and/or use one or more network and/or system communication protocols.

In addition to the deposit application 1337, the memory 1336 also includes the account datastore 1338. It will be understood that the account datastore 1338 can be configured to store any type and/or amount of information. For example, in some embodiments, the account datastore 1338 includes information associated with one or more transactions, accounts, users or account holders, and/or the like. In some embodiments, the account datastore 1338 may also store any information related to processing images captured by remote capture devices. In some embodiments, the account datastore 1338 additionally or alternatively stores information associated with electronic banking services.

Also, the account datastore 1338 may include any one or more storage devices, including, but not limited to, datastores, data repositories, databases, and/or any of the other storage devices typically associated with a computer system. It will also be understood that the account datastore 1338 may store information in any known way, such as, for example, by using one or more computer codes and/or languages, alphanumeric character strings, data sets, figures, tables, charts, links, documents, and/or the like. Further, in some embodiments, the account datastore 1338 may include information associated with one or more applications, such as, for example, the deposit application 1337. It will also be understood that, in some embodiments, the account datastore 1338 provides a real-time or substantially real-time representation of the information stored therein, so that, for example, when the processor 1334 accesses the account datastore 1338, the information stored therein is current or nearly current. The account datastore 1338 can also dynamically store information, such that the information stored therein (e.g., account balances, transaction information, rules for depositing checks, etc.) can be quickly and/or immediately added, removed, changed, revised, updated, and/or the like.

Of course, it will be understood that the embodiment of the system 1300 illustrated in FIG. 13 is exemplary and that other embodiments may vary. For example, in some embodiments, some or all of the portions of the system 1300 are combined into a single portion. Specifically, in some embodiments, the remote capture device 1320 and the banking apparatus 1330 are combined into a single remote capture and deposit device that is configured to perform all of the same functions of those separate portions as described and/or contemplated herein. Likewise, in some embodiments, some or all of the portions of the system 1300 are separated into two or more distinct portions. In addition, the various portions of the system 1300 may be maintained by the same or separate parties. For example, in some embodiments, a bank may maintain the banking apparatus 1330, whereas the remote capture device user 1305 may maintain the remote capture device 1320. However, in other embodiments, a bank may maintain the banking apparatus 1330 and the remote capture device 1320.

It will also be understood that the system 1300 (and/or one or more portions of the system 1300) may include and/or implement any embodiment of the present invention described and/or contemplated herein. For example, in some embodiments, the system 1300 (and/or one or more portions of the system 1300) is configured to implement any one or more of the embodiments of the process flow 100, 200, and/or 400 described and/or contemplated herein in connection with FIGS. 1, 2, 3, and 4.

In accordance with embodiments of the invention, the term “module” with respect to a system may refer to a hardware component of the system, a software component of the system, or a component of the system that includes both hardware and software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving information associated with an account;
determining, using a processor and based at least partially on the information, that the account is eligible to participate in a banking service; and
presenting, in an electronic banking environment accessible to a holder of the account, an identifier associated with the banking service, wherein the presenting is based at least partially on the determining that the account is eligible.

2. The method of claim 1, wherein the identifier comprises an input feature that enables the holder to enroll in the banking service.

3. The method of claim 2, further comprising:
activating the banking service for the account based at least partially on a determination that the holder has enrolled in the banking service.

4. The method of claim 3, further comprising:
presenting a second identifier in the electronic banking environment after the activating the banking service, wherein the second identifier enables the holder to use the banking service.

5. The method of claim 1, wherein the identifier comprises an input feature that enables the holder to use the banking service.

6. The method of claim 1, further comprising:
activating the banking service for the account based at least partially on the determining that the account is eligible.

7. The method of claim 1, further comprising:
receiving second information associated with the account, wherein the receiving the second information occurs after the presenting the identifier;
determining, based at least partially on the second information, that the account is ineligible to participate in the banking service; and
deactivating the banking service for the account based at least partially on the determining that the account is ineligible.

8. The method of claim 1, further comprising:
receiving second information associated with the account, wherein the receiving the second information occurs after the presenting the identifier;
determining, based at least partially on the second information, that the account is ineligible to participate in the banking service; and
removing the identifier from the electronic banking environment based at least partially on the determining that the account is ineligible.

9. The method of claim 1, further comprising:
receiving second information associated with the account, wherein the receiving the second information occurs after the presenting the identifier;
determining, based at least partially on the second information, that the account is ineligible to participate in the banking service; and
presenting, in the electronic banking environment, a message that indicates that the banking service will be deactivated, wherein the presenting the message is based at least partially on the determining that the account is ineligible.

10. The method of claim 9, wherein the message comprises a recommendation for preventing deactivation of the banking service.

11. The method of claim 1, wherein the information associated with the account comprises information associated with the holder.

12. The method of claim 1, wherein the information associated with the account comprises a risk rating associated with the account.

13. The method of claim 1, further comprising:
determining that the holder has accessed the electronic banking environment, and
wherein the receiving the information is triggered by the determining that the holder has accessed the electronic banking environment.

14. The method of claim 1, further comprising:
determining that the holder has accessed the electronic banking environment, and
wherein the receiving the information, the determining that the account is eligible, and the presenting the identifier all occur within approximately two minutes of the determining that the holder has accessed the electronic banking environment.

15. The method of claim 1, further comprising:
determining that the holder has selected the identifier, and
wherein the receiving the information, the determining that the account is eligible, and activating the banking service for the account, based at least partially on the determining that the account is eligible, all occur within approximately two minutes of the determining that the holder has selected the identifier.

16. The method of claim 1, wherein the identifier comprises information indicating that the banking service has been activated for the account.

17. The method of claim 1, wherein the electronic banking environment comprises a mobile banking environment accessible to the holder via a mobile device, wherein the mobile banking environment is configured to output transaction information associated with the account to the holder, and wherein the mobile banking environment enables the holder to perform one or more transactions using the account.

18. The method of claim 1, wherein the electronic banking environment comprises a mobile banking environment accessible to the holder via a remote capture device, and wherein the banking service comprises a mobile deposit service that enables the holder to perform a deposit transaction involving the account and using the remote capture device.

19. An apparatus comprising:
a processor configured to:
receive information associated with an account;
determine, based at least partially on the information, that the account is eligible to participate in a banking service; and
present, in an electronic banking environment accessible to a holder of the account, an identifier associated with the banking service.

20. The apparatus of claim 19, wherein the processor is further configured to:
activate the banking service for the account based at least partially on a determination that the holder has enrolled in the banking service.

21. The apparatus of claim 20, wherein the processor is further configured to:
present a second identifier in the electronic banking environment after the processor activates the banking service, wherein the second identifier enables the holder to use the banking service.

22. The apparatus of claim 19, wherein the processor is further configured to:
activate the banking service for the account based at least partially on the processor determining that the account is eligible.

23. The apparatus of claim 19, wherein the processor is further configured to:
receive second information associated with the account;
determine, based at least partially on the second information, that the account is ineligible to participate in the banking service; and
deactivate the banking service for the account based at least partially on the processor determining that the account is ineligible.

24. The apparatus of claim 19, wherein the processor is further configured to:
receive second information associated with the account;
determine, based at least partially on the second information, that the account is ineligible to participate in the banking service; and
remove the identifier from the electronic banking environment based at least partially on the processor determining that the account is ineligible.

25. The apparatus of claim 19, wherein the processor is further configured to:
receive second information associated with the account;
determine, based at least partially on the second information, that the account is ineligible to participate in the banking service; and
present, in the electronic banking environment, a message that indicates that the banking service will be deactivated, wherein the processor presents the message based at least partially on the processor determining that the account is ineligible.

26. The apparatus of claim 19, wherein the processor is further configured to:
determine that the holder has accessed the electronic banking environment, and
wherein the processor is configured such that the processor determining that the holder has accessed the electronic banking environment triggers the processor to receive the information.

27. The apparatus of claim 19, wherein the processor is further configured to:
determine that the holder has accessed the electronic banking environment, and
wherein the processor is configured such that the processor receives the information, determines that the account is eligible, and presents the identifier all within approximately two minutes of the processor determining that the holder has accessed the electronic banking environment.

28. The apparatus of claim 19, wherein the processor is further configured to:
determine that the holder has selected the identifier, and
wherein the processor is configured such that the processor's receiving the information, determining that the account is eligible, and activating the banking service for the account, based at least partially on the processor determining that the account is eligible, all occur within approximately two minutes of the processor determining that the holder has selected the identifier.

29. A computer program product comprising a non-transitory computer-readable medium, wherein the non-transitory computer-readable medium comprises one or more computer-executable program code portions that, when executed by a computer, cause the computer to:
receive information associated with an account;
determine, based at least partially on the information, that the account is eligible to participate in a banking service; and
present, in an electronic banking environment accessible to a holder of the account, an identifier associated with the banking service.

30. The computer program product of claim 29, wherein the one or more computer-executable program code portions, when executed by the computer, cause the computer to:
activate the banking service for the account based at least partially on a determination that the holder has enrolled in the banking service.

31. The computer program product of claim 30, wherein the one or more computer-executable program code portions, when executed by the computer, cause the computer to:
present a second identifier in the electronic banking environment after the computer activates the banking service, wherein the second identifier enables the holder to use the banking service.

32. The computer program product of claim 29, wherein the one or more computer-executable program code portions, when executed by the computer, cause the computer to:
activate the banking service for the account based at least partially on the computer determining that the account is eligible.

33. The computer program product of claim 29, wherein the one or more computer-executable program code portions, when executed by the computer, cause the computer to:
receive second information associated with the account;
determine, based at least partially on the second information, that the account is ineligible to participate in the banking service; and
deactivate the banking service for the account based at least partially on the computer determining that the account is ineligible.

34. The computer program product of claim 29, wherein the one or more computer-executable program code portions, when executed by the computer, cause the computer to:
receive second information associated with the account; determine, based at least partially on the second information, that the account is ineligible to participate in the banking service; and
remove the identifier from the electronic banking environment based at least partially on the computer determining that the account is ineligible.

35. The computer program product of claim 29, wherein the one or more computer-executable program code portions, when executed by the computer, cause the computer to:
receive second information associated with the account;
determine, based at least partially on the second information, that the account is ineligible to participate in the banking service; and
present, in the electronic banking environment, a message that indicates that the banking service will be deactivated.

36. The computer program product of claim 29, wherein the one or more computer-executable program code portions, when executed by the computer, cause the computer to:
determine that the holder has accessed the electronic banking environment, and
wherein the computer determining that the holder has accessed the electronic banking environment triggers the computer to receive the information.

37. The computer program product of claim 29, wherein the one or more computer-executable program code portions, when executed by the computer, cause the computer to:
determine that the holder has accessed the electronic banking environment, and
wherein the computer receives the information, determines that the account is eligible, and presents the identifier all within approximately two minutes of the computer determining that the holder has accessed the electronic banking environment.

38. The computer program product of claim 29, wherein the one or more computer-executable program code portions, when executed by the computer, cause the computer to:
determine that the holder has selected the identifier, and
wherein the computer is configured such that the computer's receiving the information, determining that the account is eligible, and activating the banking service for the account, based at least partially on the computer determining that the account is eligible, all occur within approximately two minutes of the computer determining that the holder has selected the identifier.

39. A method comprising:
receiving a risk rating associated with an account;
determining, using a processor and based at least partially on the risk rating, that the account is eligible to participate in a mobile deposit service; and
presenting, in a mobile banking environment accessible to a holder of the account, an identifier associated with the mobile deposit service, wherein the presenting is based at least partially on the determining that the account is eligible.

40. The method of claim 39, wherein the identifier comprises an input feature that enables the holder to enroll in the mobile deposit service.

41. The method of claim 40, further comprising:
activating the mobile deposit service for the account based at least partially on a determination that the holder has enrolled in the mobile deposit service.

42. The method of claim 41, further comprising:
presenting a second identifier in the mobile banking environment after the activating the mobile deposit service, wherein the second identifier enables the holder to use the mobile deposit service.

43. The method of claim 39, wherein the identifier comprises an input feature that enables the holder to use the mobile deposit service.

44. The method of claim 39, further comprising:
activating the mobile deposit service for the account based at least partially on the determining that the account is eligible.

45. The method of claim 39, further comprising:
receiving an updated risk rating associated with the account, wherein the receiving the updated risk rating occurs after the presenting the identifier;
determining, based at least partially on the updated risk rating, that the account is ineligible to participate in the mobile deposit service; and
deactivating the banking service for the account based at least partially on the determining that the account is ineligible.

46. The method of claim 39, further comprising:
receiving an updated risk rating associated with the account, wherein the receiving the updated risk rating occurs after the presenting the identifier;
determining, based at least partially on the updated risk rating, that the account is ineligible to participate in the mobile deposit service; and
removing the identifier from the electronic banking environment based at least partially on the determining that the account is ineligible.

47. The method of claim 39, further comprising:
determining the risk rating associated with the account based at least partially on a transaction history associated with the account.

48. The method of claim 39, wherein the determining that the account is eligible comprises determining that the risk rating associated with the account is less than a predetermined risk threshold for participating in the mobile deposit service.

49. The method of claim 39, further comprising:
determining that the holder has accessed the mobile banking environment, and
wherein the receiving the risk rating is triggered by the determining that the holder has accessed the electronic banking environment.

50. The method of claim 39, further comprising:
determining that the holder has accessed the electronic banking environment, and
wherein the receiving the risk rating, the determining that the account is eligible, and the presenting the identifier all occur within approximately two minutes of the determining that the holder has accessed the mobile banking environment.

51. The method of claim 39, further comprising:
determining that the holder has selected the identifier, and
wherein the receiving the risk rating, the determining that the account is eligible, and activating the mobile deposit service for the account based at least partially on the determining that the account is eligible all occur within approximately two minutes of the determining that the holder has selected the identifier.

52. The method of claim 39, wherein the mobile banking environment is accessible to the holder via a remote capture device, and wherein the mobile deposit service enables the holder to perform a deposit transaction involving the account and using the remote capture device.

53. A method comprising:
presenting, in an electronic banking environment accessible to a holder of an account, an identifier associated with a banking service;
determining that the holder has selected the identifier;
receiving, based at least partially on determining that the holder has selected the identifier, information associated with the account; and
determining, using a processor and based at least partially on the information, that the account is eligible to participate in the banking service.

54. The method of claim 53, further comprising:
activating the banking service for the account based at least partially on the determining that the account is eligible.
